(19) United States
(12) Patent Application Publication
(10) Pub. No.: US 2023/0378658 A1
(43) Pub. Date: Nov. 23, 2023

(54) MATCHING NETWORK FOR ANTENNA ELEMENT OF ANTENNA ARRAY AND ELECTRONIC DEVICE INCLUDING THE SAME

(71) Applicant: Samsung Electronics Co., Ltd., Suwon-si (KR)

(72) Inventors: Jun HUR, Suwon-si (KR); Jongmin LEE, Suwon-si (KR); Seungho CHOI, Suwon-si (KR); Byungchul KIM, Suwon-si (KR); Jungmin PARK, Suwon-si (KR); Bumhee LEE, Suwon-si (KR)

(21) Appl. No.: 18/188,709

(22) Filed: Mar. 23, 2023

Related U.S. Application Data
(63) Continuation of application No. PCT/KR2023/003380, filed on Mar. 13, 2023.

(30) Foreign Application Priority Data
May 23, 2022 (KR) 10-2022-0063110
Jun. 7, 2022 (KR) 10-2022-0068895

(51) Int. Cl. H01Q 21/00; H01Q 21/24; H01Q 1/48; H01Q 1/24

(52) U.S. Cl. CPC H01Q 21/0006; H01Q 21/24; H01Q 1/48; H01Q 1/246

(57) ABSTRACT

An electronic device including a sub-array module is provided. The electronic device includes an antenna substrate, a plurality of antenna element units, a first divider for a first polarization, and a second divider for a second polarization. Each antenna element unit of the plurality of antenna element units includes an antenna element for an emission of a signal, a first feeding structure for the first polarization, a second feeding structure for the second polarization, a first connecting structure for branching the first feeding structure and the first divider, and a second connecting structure for branching the second feeding structure and the second divider.

### CROSS-REFERENCE TO RELATED APPLICATION(S)

This application is a continuation application, claiming priority under § 365(c), of an International Application No. PCT/KR2023/003380, filed on Mar. 13, 2023, which is based on and claims the benefit of a Korean patent application number 10-2022-0063110, filed on May 23, 2022, in the Korean Intellectual Property Office, and of a Korean patent application number 10-2022-0068895, filed on Jun. 7, 2022, in the Korean Intellectual Property Office, the disclosure of each of which is incorporated by reference herein in its entirety.

### TECHNICAL FIELD

The disclosure relates to an antenna array. More particularly, the disclosure relates to a matching network for an antenna element of an antenna array and an electronic device including the same.

### BACKGROUND ART

An electronic device using beamforming technology of a wireless communication system includes a plurality of antenna elements. A divider may transmit an input signal to each of the antenna elements. At that time, distortion may occur in a signal applied to the antenna element.

The above information is presented as background information only to assist with an understanding of the disclosure. No determination has been made, and no assertion is made, as to whether any of the above might be applicable as prior art with regard to the disclosure.

### DISCLOSURE

### Technical Solution

In embodiments of the disclosure, an electronic device including a sub-array module is provided. The electronic device includes an antenna substrate, a plurality of antenna element units, a first divider for a first polarization, and a second divider for a second polarization. Each antenna element unit of the plurality of antenna element units may comprise an antenna element for an emission of a signal, a first feeding structure for the first polarization, a second feeding structure for the second polarization, a first connecting structure for branching the first feeding structure and the first divider, and a second connecting structure for branching the second feeding structure and the second divider.

In embodiments of the disclosure, an electronic device is provided. The electronic device includes a processor, radio frequency (RF) processing chains, a filter module, and an antenna array module including a plurality of sub-arrays. Each sub-array of the plurality of sub-arrays may include an antenna substrate, a plurality of antenna element units, a first divider for a first polarization, and a second divider for a second polarization. Each antenna element unit of the plurality of antenna element units may include an antenna element for an emission of a signal, a first feeding structure for the first polarization, a second feeding structure for the second polarization, a first connecting structure for branching the first feeding structure and the first divider, and a second connecting structure for branching the second feeding structure and the second divider.

### DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIGS. 2A and 2B illustrate an example of a grating lobe according to embodiments of the disclosure;

FIG. 3 illustrates an example of an antenna element unit including a connecting structure according to an embodiment of the disclosure;

FIGS. 4A and 4B illustrate signal distortion according to the presence or absence of a connecting structure according to embodiments of the disclosure;

FIG. 5 illustrates an example of a stacked structure of an electronic device including an antenna element unit according to an embodiment of the disclosure;

FIGS. 6A, 6B, 6C, and 6D illustrate other examples of a stacked structure of an electronic device including an antenna element unit according to embodiments of the disclosure;

FIG. 7 illustrates an example of a design procedure of a sub-array including an antenna element unit according to an embodiment of the disclosure;

FIGS. 8A and 8B illustrate removal performance of the grating lobe of the sub-array including the antenna element unit according to embodiments of the disclosure;

FIG. 9 illustrates shapes of a connecting structure of an antenna element unit according to an embodiment of the disclosure;

FIGS. 10A and 10B illustrate examples of sub-arrays including antenna element units according to embodiments of the disclosure;

FIG. 11 illustrates an example of a sub-array module including antenna element units according to an embodiment of the disclosure;

FIG. 12A illustrates an example of an antenna element unit for a 4-port according to an embodiment of the disclosure;

FIG. 12B illustrates an example of a sub-array including antenna element units for a 4-port according to an embodiment of the disclosure;

FIG. 13 illustrates an example of a sub-array module including antenna element units for a 4-port according to an embodiment of the disclosure;

FIGS. 14A and 14B illustrate examples of a sub-array including antenna element units for 4-ports according to embodiments of the disclosure; and

FIG. 15 illustrates a functional configuration of an electronic device including an antenna array having an antenna element unit according to an embodiment of the disclosure.

Throughout the drawings, like reference numerals will be understood to refer to like parts, components, and structures.

### MODE FOR INVENTION

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach is described as an example. However, since the various embodiments of the disclosure include technology that use both hardware and software, the various embodiments of the disclosure do not exclude a software-based approach.

A term referring to a signal (e.g., signal, signal flow, compound signal, digital signal, analog signal, modulation signal, distortion signal), a term referring to a resource (e.g., time, symbol, slot, subframe, radio frame, subcarrier, resource element (RE), resource block (RB), bandwidth part (BWP), occasion), a term for an operational state (e.g., step, operation, procedure), a term referring to a channel, a term referring to a network entity, a term referring to a component of a device, and the like used in the following description are illustrated for convenience of description. Thus, the disclosure is not limited to terms described below, and another term having an equivalent technical meaning may be used.

A term referring to a component of an electronic device (substrate, print circuit board (PCB), flexible PCB (FPCB), module, antenna, antenna element, circuit, processor, chip, component, instrument), a term referring to a shape of a component (e.g., structure, construction, supporting part, contacting part, protruding part), a term referring to a circuit (e.g., PCB, FPCB, signal line, feeding line, data line, RF signal line, antenna line, RF path, RF module, RF circuit, splitter, divider, coupler, combiner), and the like used in the following description are illustrated for convenience of description. Accordingly, the disclosure is not limited to terms described below, and another term having an equivalent technical meaning may be used. In addition, a term such as ‘ . . . part’, ‘ . . . er’, ‘ . . . structure’, ‘ . . . body’, and the like used below may mean at least one shape structure, or may mean a unit that processes a function.

In addition, in the disclosure, in order to determine whether a specific condition is satisfied or fulfilled, an expression of more than or less than may be used, but this is only a description for expressing an example, and does not exclude description of more than or equal to or less than or equal to. A condition described as ‘more than or equal to’ may be replaced with ‘ more than’, a condition described as ‘less than or equal to’ may be replaced with ‘less than’, and a condition described as ‘more than or equal to and less than’ may be replaced with ‘more than and less than or equal to’. In addition, hereinafter, ‘A’ to ‘B’ means at least one of elements from A (including A) to B (including B).

The disclosure is to provide a structure for impedance matching for each antenna elements and an electronic device including the same, in an electronic device including an antenna array.

The disclosure is to provide a matching network for reducing the influence due to a grating lobe in an electronic device including an antenna array and an electronic device including the same.

A matching network according to embodiments of the disclosure and an electronic device including a matching network can make impedance matching for each antenna element possible by connecting an additional structure to a feeding part of the antenna element.

A matching network according to embodiments of the disclosure and an electronic device including the same can reduce the influence of the grating lobe and increase the performance of the antenna array through impedance matching for each antenna element.

The effects that can be obtained from the present disclosure are not limited to those described above, and any other effects not mentioned herein will be clearly understood by those having ordinary knowledge in the art to which the present disclosure belongs, from the following description.

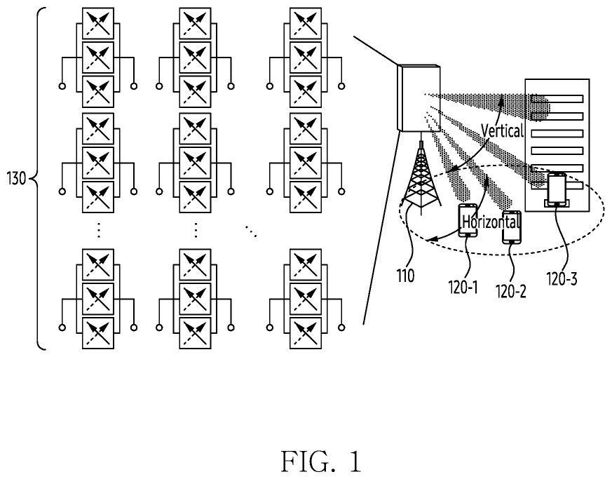

FIG. 1 illustrates a wireless communication system according to an embodiment of the disclosure.

The wireless communication environment 100 of FIG. 1 illustrates a base station 110 and a terminal 120 as parts of nodes using a wireless channel.

Referring to FIG. 1, a base station 110 is a network infrastructure that provides wireless access to the terminal 120. The base station 110 has coverage based on a distance capable of transmitting a signal. In addition to the base station, the base station 110 may be referred to as ‘access point (AP), eNodeB (eNB), ‘5th generation node’, fifth-generation (5G) NodeB (5G NB), wireless point, transmission/reception point (TRP), access unit, distributed unit (DU), radio unit (RU), remote radio head (RRH), or other terms having an equivalent technical meaning. The base station 110 may transmit a downlink signal or receive an uplink signal.

A terminal 120-1, a terminal 120-2, or a terminal 120-3 is a device used by a user and communicates with the base station 110 through a wireless channel. Hereinafter, a description of the terminal 120-1, the terminal 120-2, or the terminal 120-3 will be described by referring to the terminal 120. In some cases, the terminal 120 may be operated without user involvement. That is, the terminal 120 is a device that performs machine type communication (MTC) and may not be carried by a user. The terminal 120 may be referred to as ‘user equipment (UE)’, ‘mobile station’, ‘subscriber station’, ‘customer premises equipment (CPE), ‘remote terminal’, ‘wireless terminal’, ‘electronic device’, or ‘terminal for vehicle’, ‘user device’, or other terms having an equivalent technical meaning in addition to the terminal.

As one of the technologies for mitigating radio wave path loss and increasing the transmission distance of radio waves, beamforming technology is being used. Beamforming generally uses a plurality of antennas to concentrate the reach area of the radio wave or increase the directivity of the reception sensitivity with respect to a specific direction. Therefore, the base station 110 may have a plurality of antennas, in order to form a beamforming coverage instead of forming a signal in an isotropic pattern using a single antenna. According to an embodiment, the base station 110 may include a Massive multiple input multiple output (MIMO) Unit (MMU). A form in which a plurality of antennas are assembled may be referred to as an antenna array 130, and each antenna included in the array may be referred to as an array element or an antenna element. The antenna array 130 may be configured in various forms such as a linear array, a planar array, and the like. The antenna array 130 may be referred to as a massive antenna array.

The main technology for improving the data capacity of 5G communication is beamforming technology that uses antenna arrays connected to a plurality of RF paths. For higher data capacity, the number of RF paths should be increased or the power of the RF paths should be increased. Increasing the RF path will increase the size of the product, but it is currently at a level that can no longer be increased due to spatial constraints in installing actual base station equipment. In order to increase antenna gain through high output without increasing the number of RF paths, antenna gain can be increased by connecting a plurality of antenna elements to the RF path using a divider (or splitter). Here, an antenna element corresponding to the RF path may be referred to as a sub-array.

The number of antennas (or antenna elements) of equipment (e.g., the base station 110) that performs wireless communication to improve communication performance is increasing. In addition, since the number of RF parts (e.g., amplifiers, filters) and components for processing RF signals received or transmitted through antenna elements increases, spatial gains and cost-effectiveness are also important along with communication performance, when configuring communication equipment.

Hereinafter, in order to describe a matching network of an antenna element and an electronic device including the same, the base station 110 of FIG. 1 is described as an example, but embodiments are not limited thereto. According to embodiments of the disclosure, in addition to the base station 110, wireless equipment that performs functions equivalent to the base station, wireless equipment connected to the base station (e.g., TRP), the terminal 120 in FIG. 1, or any other communication equipment used for 5G communication may serve as a matching network and an electronic device including the same.

Hereinafter, an antenna array composed of sub-arrays will be described as an example as a structure of a plurality of antennas for communication in a multiple input multiple output (MIMO) environment, an easy modification for beamforming is possible in some embodiments.

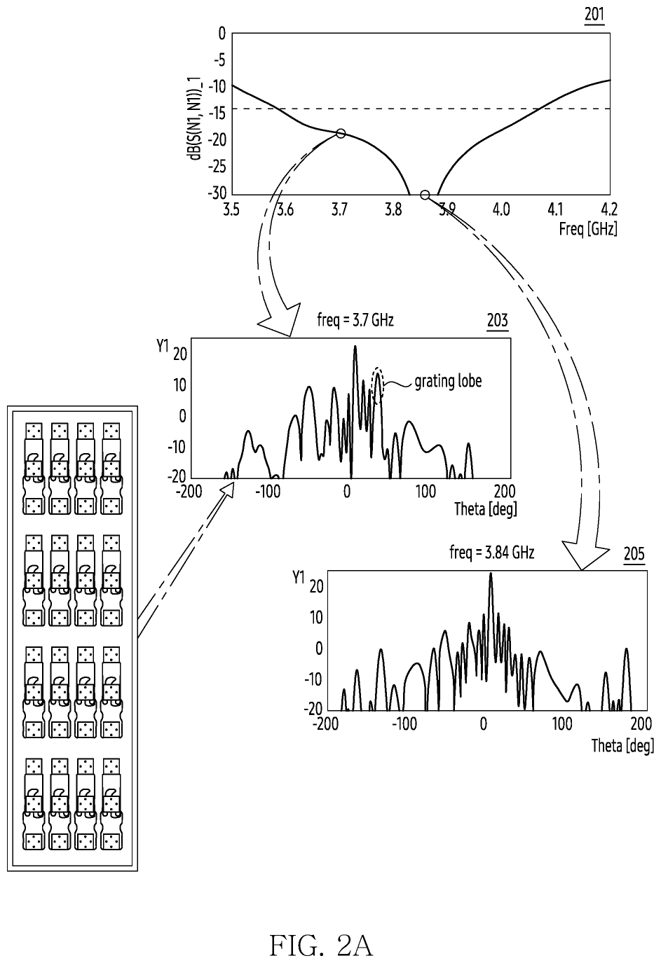

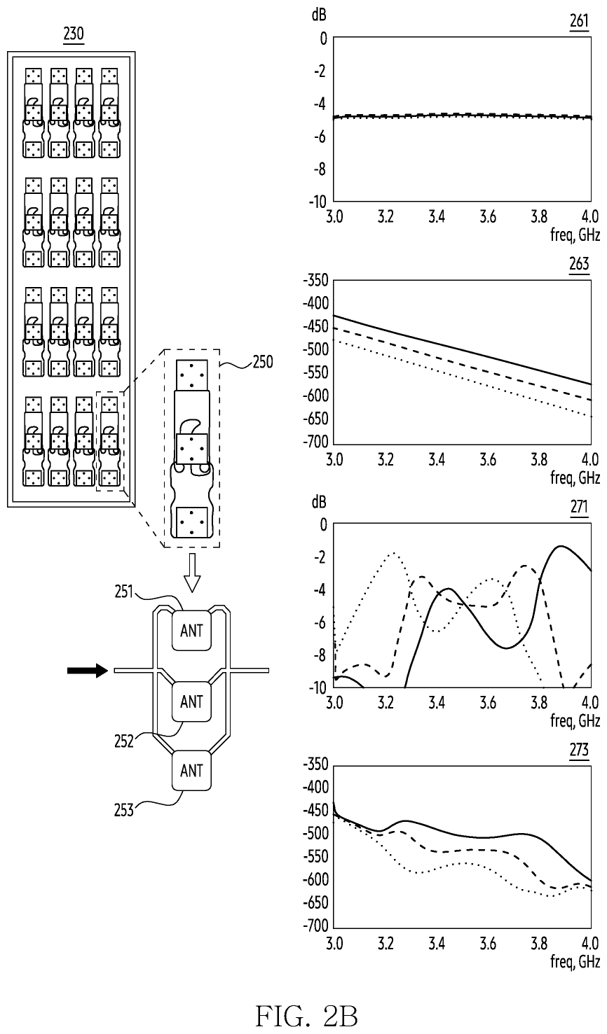

FIGS. 2A and 2B illustrate an example of a grating lobe according to embodiments of the disclosure.

Referring to FIG. 2A, the graph 201 shows a return loss for each frequency. The horizontal axis of the graph 201 represents frequency (unit: gigahertz (GHz)), and the vertical axis of the graph 201 represents return loss (unit: decibel (dB). The graph 203 shows a gain for each radiation angle at 3.7 GHz. The horizontal axis of the graph 203 represents a radiation angle (unit: degree) and the vertical axis of the graph 203 represents a gain (unit: dB). The graph 205 shows a gain for each radiation angle at 3.84 GHz. The horizontal axis of the graph 205 represents a radiation angle (unit: degree), and the vertical axis of the graph 205 represents a gain.

As illustrated in the graph 201, at a central frequency (e.g., 3.84 GHz), the antenna array may provide a lower return loss than other frequencies. Within a frequency range having a return loss of less than or equal to a certain reference (e.g., 15 dB), a certain gain may be guaranteed. Due to low return loss, the antenna array may perform broadband communication. However, as illustrated in the graph 203, in the case of moving away from the central frequency, a grating lobe may occur in addition to the main lobe in a vertical plane pattern.

Such a grating lobe mainly occurs in an antenna array in which a plurality of antenna elements are arranged. As the number of antenna elements increases, the beam width of the main lobe decreases and the influence due to the side lobe increases. The sum of signals of antenna elements in a specific direction (e.g., direction in which the phase is a multiple of 2π) other than the direction of the main lobe may be maximized. The pattern in the specific direction may be referred to as a grating lobe. The grating lobe may occur even in a band in which a return loss is secured (e.g., 3.7 GHz). The grating lobe deteriorates the peak gain and the adjusting range.

Referring to FIG. 2B, the antenna array 230 may include a plurality of sub-arrays. The sub-array 250 may include a plurality of antenna elements (e.g., three). For example, the sub-array 250 may include a first antenna element 251, a second antenna element 252, and a third antenna element 253. Hereinafter, in each of the graph 261, the graph 263, the graph 271, and the graph 273, a solid line represents an index for the first antenna element 251. In each of the graph 261, the graph 263, the graph 271, and the graph 273, a broken line represents an index for the second antenna element 252. In each of the graph 261, the graph 263, the graph 271, and the graph 273, a dotted line represents an index for the third antenna element 253.

An input signal may be supplied to each of the first antenna element 251, the second antenna element 252, and the third antenna element 253. Each antenna element may radiate the input signal into the air. The graph 261 represents a magnitude of an ideal signal. A horizontal axis of the graph 261 represents a frequency (unit: GHz), and a vertical axis represents a gain (unit: dB). Since the applied input signals are the same, the magnitudes of the radiated signals may all be the same. The graph 263 represents an ideal phase of the signal. The horizontal axis of the graph 263 represents a frequency (unit: GHz), and the vertical axis represents a phase difference (unit: degree). In order to change the phases of the radiation signals, a phase difference of a predetermined interval (e.g., 30 degrees) exists between adjacent antenna elements.

Unlike the graphs 261 and 263, the actual signal has a different aspect due to the influence of distortion. The graph 271 represents a magnitude of a realistic signal. A horizontal axis of the graph 271 represents a frequency (unit: GHz), and a vertical axis represents a gain (unit: dB). The graph 273 represents a phase of the realistic signal. A horizontal axis of the graph 273 represents a frequency (GHz), and a vertical axis represents a phase difference (unit: degree).

When the input signal is transmitted to each antenna element through a divider, distortion of the signal may occur. The signal distortion changes the magnitude of the ideal signal or the phase difference of the ideal signal. As shown in the graph 271 and graph 273, as the required bandwidth increases (i.e., when using broadband), the effect due to signal distortion increases.

The characteristic impedance of the antenna element may be frequency dependent. In central frequency, return loss is small through impedance matching. However, as the bandwidth increases, the range of central frequency and other frequencies increases. At frequencies other than the central frequency, the magnitude of the characteristic impedance may vary due to the reactance of the antenna. The change in the characteristic impedance magnitude changes the magnitude of the signal according to the frequency.

In order to control the beam direction of the sub-array, phases for antenna elements (e.g., the first antenna element 251, the second antenna element 252, and the third antenna element 253) may be different from each other. However, the electrical length for each antenna element may vary depending on the frequency, and a changed electrical length causes non-linearity of phase changes for each frequency. The phase and signal magnitude having non-linearity at the frequency may cause a grating lobe.

The Return loss is designed in units of sub-arrays in which antenna elements and divider(s) are combined. In this case, if only the design of adjusting the resonance frequency of the antenna element to the center of the frequency band is performed, it is difficult to match the impedance of each antenna element unit. That is, since the impedance matching of each antenna element unit is difficult, a grating lobe may occur at a frequency different from the central frequency. Therefore, the disclosure proposes a plan to reduce the effect of signal distortion due to antenna reactance and reduce the grating lobe, by performing impedance matching in antenna element units, not in sub-array units.

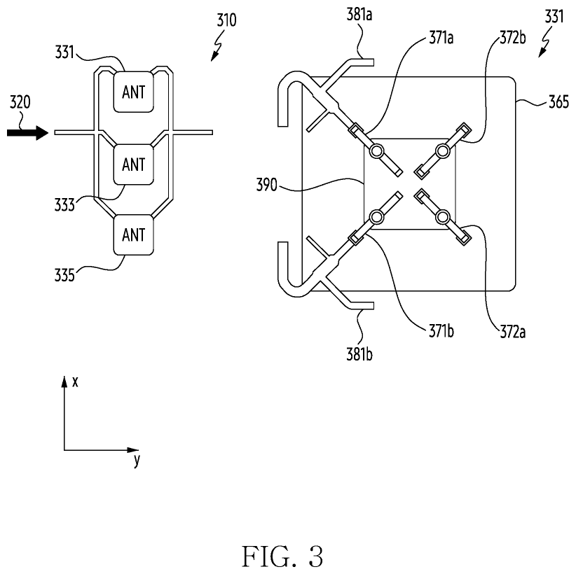

FIG. 3 illustrates an example of an antenna element unit including a connecting structure according to an embodiment of the disclosure.

Referring to FIG. 3, the sub-array 310 may include a first antenna element unit 331, a second antenna element unit 333, and a third antenna element unit 335. The first antenna element unit 331, the second antenna element unit 333, and the third antenna element unit 335 may be coupled to the first divider. The first divider may feed a signal for a first polarization to each antenna element at the RF port. The first antenna element unit 331, the second antenna element unit 333, and the third antenna element unit 335 may be coupled to the second divider. The second divider may feed a signal for a second polarization to each antenna element at the RF port. For example, the first polarization means the polarization of (+)45 degrees. The second polarization means a (−)45 degree polarization. The first polarization and the second polarization may be orthogonal to each other.

The input signal 320 may be transmitted to each of the first antenna element unit 331, the second antenna element unit 333, and the third antenna element unit 335 through a divider (the first divider or the second divider). Embodiments of the disclosure propose a method for impedance matching in antenna element units to remove the grating lobe. For impedance matching in antenna element units, the signal from the divider's branch may be radiated through the antenna element unit. Hereinafter, although the first antenna element unit 331 is described as an example for explaining the antenna element unit, descriptions to be described later may be equally applied to other antenna element units (e.g., the second antenna element unit 333 and the third antenna element unit 335).

The antenna element unit (e.g., the first antenna element unit 331) according to embodiments may include an antenna element 365, a first feeding structure 371a, a second feeding structure 371b, a third feeding structure 372a, a fourth feeding structure 372b, and a first connecting structure 381a and a second connecting structure 381b.

The antenna element 365 may refer to a radiator for radiating a fed signal into the air. According to an embodiment, the antenna element 365 may include a radiation patch.

The first feeding structure 371a, the second feeding structure 371b, the third feeding structure 372a, and the fourth feeding structure 372b are components for feeding an applied signal to the antenna element 365. According to an embodiment, the first feeding structure 371a and the third feeding structure 372a may be disposed in a direction of the first polarization. According to an embodiment, the second feeding structure 371b and the fourth feeding structure 372d may be disposed in a direction of the second polarization.

The first feeding structure 371a, the second feeding structure 371b, the third feeding structure 372a, and the fourth feeding structure 372b may support the antenna element through the support structure 390. Each of the first feeding structure 371a, the second feeding structure 371b, the third feeding structure 372a, and the fourth feeding structure 372b may be coupled to the support structure 390. On the other hand, unlike the figure shown in FIG. 3, each feeding structures may be configured to support the antenna element without the support structure 390.

The first connecting structure 381a may be connected to the first feeding structure 371a. The first connecting structure 381a may be connected to a first divider for the first polarization. In other words, the first connecting structure 381a may be disposed between the first feeding structure 371a and the first divider. The first connecting structure 381a may be disposed for impedance matching of the antenna element 365. In other words, the first connecting structure 381a may be configured to reduce the reactance of the characteristic impedance from the branch of the first divider to the antenna element 365.

The second connecting structure 381b may be connected to the second feeding structure 371b. The second connecting structure 381b may be connected to a second divider for the second polarization. In other words, the second connecting structure 381b may be disposed between the second feeding structure 371b and the second divider. The second connecting structure 381b may be disposed for impedance matching of the antenna element 365. In other words, the second connecting structure 381b may be configured to reduce the reactance of the characteristic impedance from the branch of the second divider to the antenna element 365.

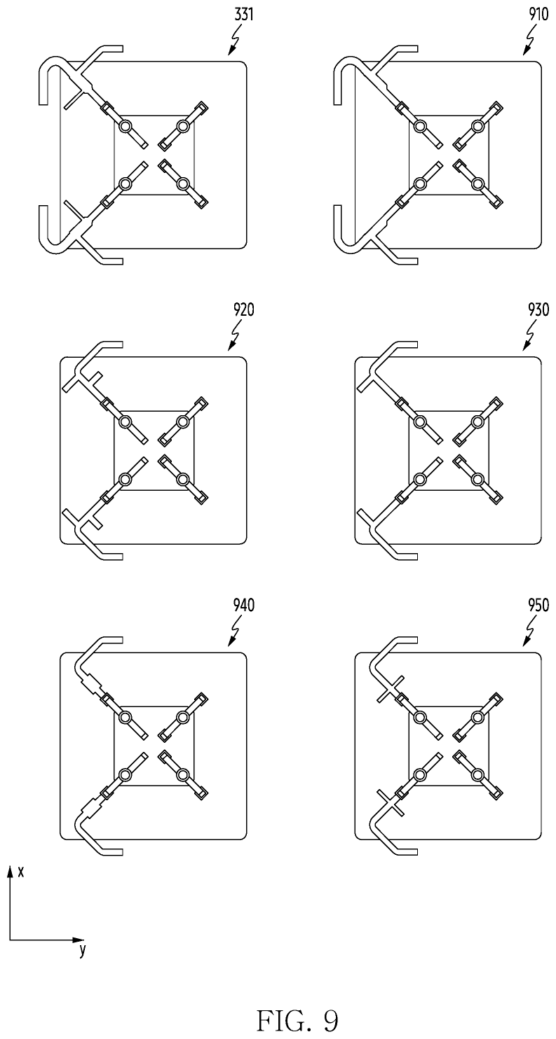

Although the shape of the connecting structure (e.g., the first connecting structure 381a and the second connecting structure 381b) for impedance matching is illustrated in FIG. 3, the embodiments of the disclosure are not limited thereto. The shape of the connecting structure can be changed in various ways if the technical principles using impedance matching are the same. Specific examples of the shape of the connecting structure are described with reference to FIG. 9.

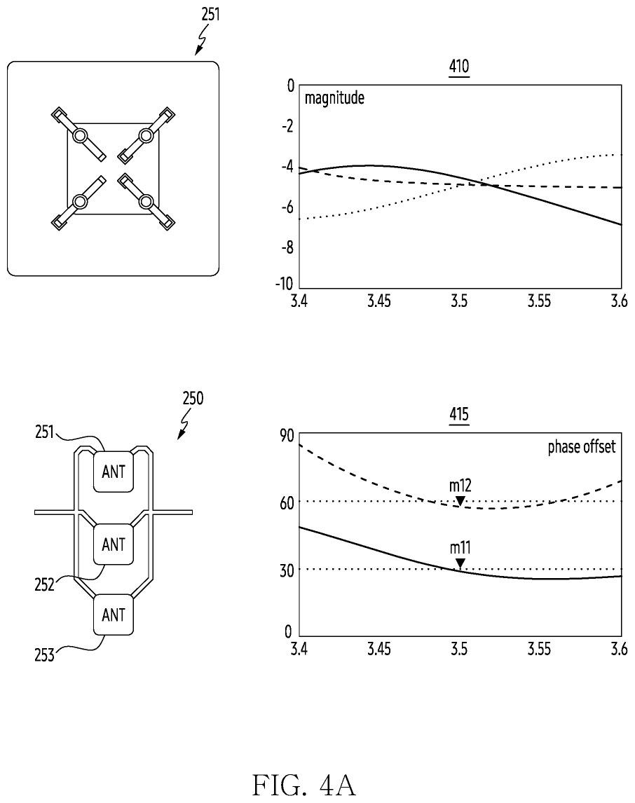

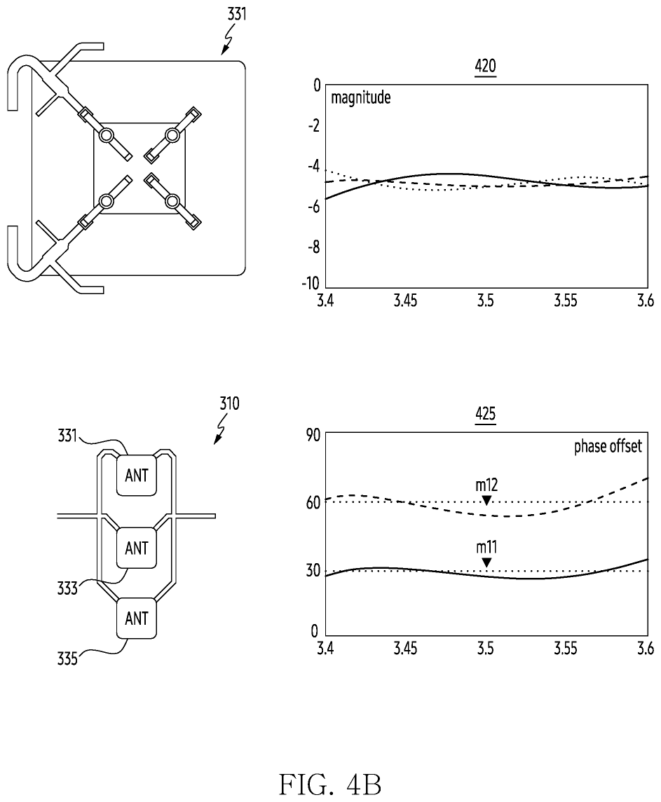

FIGS. 4A and 4B illustrate signal distortion according to the presence or absence of a connecting structure according to embodiments of the disclosure.

The sub-array 250 of FIG. 2B is illustrated to describe a sub-array without a connecting structure. The sub-array 310 of FIG. 3 is illustrated to describe a sub-array including a connecting structure.

Referring to FIG. 4A, in each of the graph 410 and the graph 415, a solid line represents an index for the first antenna element 251. In each of the graph 410 and the graph 415, a broken line represents an index for the second antenna element 252. In each of the graph 410 and the graph 415, a dotted line represents an index for the third antenna element 253.

The graph 410 represents a magnitude of a signal for each antenna element of the sub-array 250. A horizontal axis of the graph 410 represents a frequency (unit: GHz), and a vertical axis represents a gain (unit: dB). The graph 415 represents a phase of a signal for each antenna element of the sub-array 250. A horizontal axis of the graph 415 represents a frequency (unit: GHz), and a vertical axis represents a phase difference (unit: degree).

Referring to FIG. 4B, in each of the graph 420 and the graph 425, the solid line represents an index for the first antenna element unit 331. In each of the graph 420 and the graph 425, the broken line represents an index for the second antenna element unit 333. In each of the graph 420 and the graph 425, a dotted line represents an index for the third antenna element unit 335.

The graph 420 represents a magnitude of a signal for each antenna element of the sub-array 310. A horizontal axis of the graph 420 represents a frequency (unit: GHz), and a vertical axis represents a gain (unit: dB). The graph 425 represents a phase of a signal for each antenna element of the sub-array 310. A horizontal axis of the graph 425 represents a frequency (unit: GHz), and a vertical axis represents a phase difference (unit: degree).

Comparing graphs 410 and 420, it is confirmed that the change in the magnitude of the signal of the sub-array 310 using the antenna element unit is relatively more linear than the change in the magnitude of the signal of the sub-array 250. Non-linearity of magnitude with respect to frequency may be alleviated through the sub-array 310 using the antenna element unit.

Comparing graphs 415 and 425, it is confirmed that the phase change of the signal of the sub-array 310 using the antenna element unit is relatively more linear than the phase change of the signal of the sub-array 250. Non-linearity of the phase with respect to the frequency may be alleviated through the sub-array 310 using the antenna element unit.

As described in FIGS. 3, 4A, and 4B, it is possible to design impedance matching in units of the antenna element by disposing an additional structure between the antenna element and the branch of the divider. That is, the additional structure may function as a matching network. In addition to the connecting structure of FIG. 3, the additional structure may be referred to as terms such as a connection structure, a matching structure, a matching circuit, an external structure, a connecting part, a matching network, and an external matching network. When the output signal from the divider branch is fed to the antenna element, the additional structure may be designed to have a return loss below a threshold value (e.g., 20 dB) within a specified frequency range. To reduce the removal of the grating lobe from broadband, each structure may be designed through hard matching so that a return loss of less than or equal to a threshold (e.g., 20 dB) is provided at all frequencies within the specified frequency range. Non-linearity may be alleviated through the arrangement and design of structures for each antenna element. As described through FIGS. 2A and 2B, alleviation of non-linearity may reduce the effect due to the grating lobe.

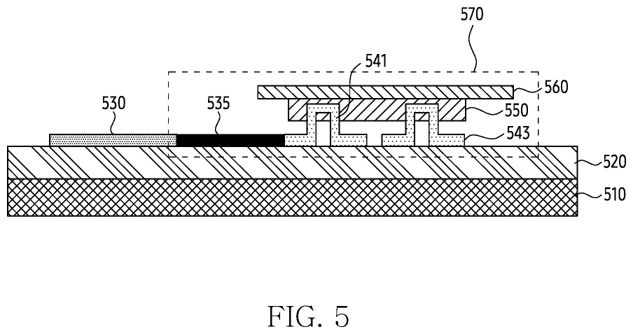

FIG. 5 illustrates an example of a stacked structure of an electronic device including an antenna element unit according to an embodiment of the disclosure.

The stacked structure illustrated in FIG. 5 refers to a cross-section of a sub-array module of an electronic device. The sub-array module of the electronic device may include a substrate on which a sub-array is disposed. The subarray of the electronic device may include a plurality of antenna element units and a divider(s).

Referring to FIG. 5, the electronic device may include a metal plate 510. The metal plate 510 may provide a ground for the sub-array. An antenna substrate 520 may be disposed on one surface of the metal plate 510. According to an embodiment, the antenna substrate 520 may be a PCB. In addition, according to an embodiment, the antenna substrate 520 may be a dielectric substrate. A divider 530 may be mounted on one surface of the antenna substrate 520. The antenna substrate 520 may be coupled to the metal plate on a surface opposite to the one surface.

The divider 530 may include a plurality of branches. The signal input from the RF port may be fed to each antenna element through the divider 530. The number of branches of the divider 530 corresponds to the number of antenna elements. Although FIG. 5 illustrates one divider as a cross-section, the embodiments of disclosure are not limited thereto. A divider having different polarization may be additionally disposed in a different area on the same surface of the antenna substrate 520. The branch of the divider 530 may be connected to the connecting structure 535.

The connecting structure 535 may be disposed on one surface of the antenna substrate 520. The connecting structure 535 may be continuously disposed on the same surface as the divider 530. The connecting structure 535 may be connected to the first feeding structure 541. The connecting structure 535 may be disposed between the antenna element 560 corresponding to the branch of the divider 530 and the branch of the divider 530. The connecting structure 535 may transmit a signal received from the branch of the divider 530 to the antenna element 560 corresponding to the branch of the divider 530. The connecting structure 535 may function as a matching network for the antenna element 560. The connecting structure 535 may be configured to reduce the reactance of the characteristic impedance related to the antenna element 560 viewed from the branch of the divider 530. The antenna element unit 570 including the connecting structure 535 may provide a characteristic impedance such that return loss for each frequency in the bandwidth is less than or equal to a threshold value.

The first feeding structure 541 and the third feeding structure 543 may be disposed on one surface of the antenna substrate 520. According to an embodiment, the first feeding structure 541 may be disposed to support the antenna element 560. The third feeding structure 543 may be disposed to support the antenna element 560. For example, a shape of the first feeding structure 541 may be a pulse. A shape of the third feeding structure 543 may be a pulse. The first feeding structure 541 and the third feeding structure 543 may be coupled to the antenna element 560 through the support structure 550. The support structure 550 may be in contact with one surface of the antenna element 560. The first feeding structure 541 may feed a signal to the antenna element 560 through coupling. Since the first feeding structure 541 does not directly contact the antenna element 560, coupling power supply is illustrated in FIG. 5, but embodiments of the disclosure are not limited thereto. Unlike that shown in FIG. 5, according to another embodiment, the first feeding structure 541 may be disposed to contact the antenna element 560. The first feeding structure 541 may directly feed a signal to the antenna element 560.

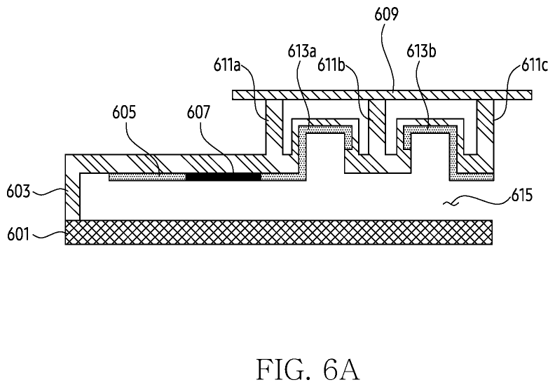

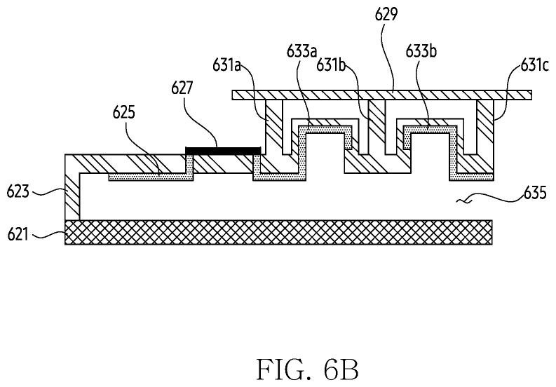

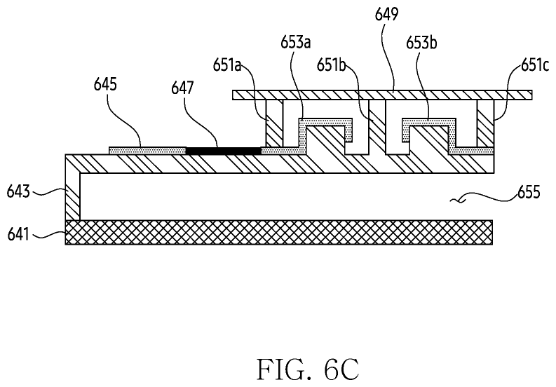

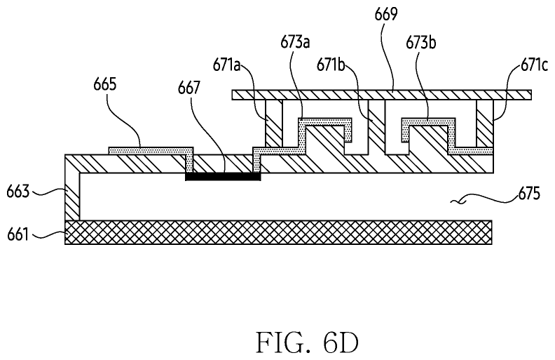

Referring to FIG. 5, a cross-section of the sub-array module to which the surface of the metal plate 510 and the surface of the antenna substrate 520 are coupled is illustrated. However, embodiments of the disclosure are not limited thereto. An air layer may be located between the antenna substrate and the metal plate. At least a part of the dielectric may include a pillar shape for coupling to the metal plate. Through the pillar shape, one surface of the dielectric may form a certain gap with the metal plate. Hereinafter, examples of cross-sections of a sub-array module including a dielectric forming a gap with the metal plate will be described with reference to FIGS. 6A to 6D.

FIGS. 6A to 6D illustrate other examples of a stacked structure of an electronic device including an antenna element unit according to embodiments of the disclosure.

Referring to FIG. 6A, the electronic device may include a metal plate 601. The metal plate 601 may provide a ground for the sub-array. A dielectric 603 may be disposed on one surface of the metal plate 601.

The dielectric 603 may include a coupling part. The coupling part of the dielectric 603 may be coupled to the one surface of the metal plate 601. The shape of the coupling part of the dielectric 603 may include a structure for supporting the dielectric 603 from the metal plate 601. The substrate part of the dielectric 603 may form a gap 615 with the metal plate 601 through the coupling part of the dielectric 603.

The dielectric 603 may include a substrate part. The substrate part of the dielectric 603 refers to an area including a surface on which a transmission line (not shown), a divider 605, and a connecting structure 607 may be disposed. The shape of the dielectric 603 may include a plate-shaped structure. According to an embodiment, the divider 605, the connecting structure 607, the first feeding structure 613a, and the second feeding structure 613b may be disposed along one surface of the dielectric 603. Unlike FIG. 5, one surface of the dielectric 603 on which the described feeding elements are disposed may face to one surface of the metal plate 601. One surface of the metal plate 601 is a surface coupled to a coupling part of the dielectric 603.

The dielectric 603 may include a support part 611a, a support part 611b, and a support part 611c. The shapes of the support part 611a, the support part 611b, and the support part 611c may include a structure for supporting the antenna element 609. The dielectric 603 may serve as a role of support of the antenna element 609 as well as a role of the antenna substrate.

The dielectric 603 may include one or more protrusion parts. One or more protrusion parts may be formed at a position higher than the substrate part of dielectric 603, so that the power feeding to the antenna element 609 is performed at a short distance based on the metal plate 601. Since the first feeding structure 613a and the second feeding structure 613b are disposed along one surface of the dielectric 603, the feeding position of the first feeding structure 613a and the feeding position of the second feeding structure 613b may be closer to the antenna element 609. Accordingly, the gain of the sub-array module increases.

The signal fed to the connecting structure 607 through the divider 605 may be transmitted to the antenna element 609 through the first feeding structure 613a. According to an embodiment, a gap exists between the first feeding structure 613a and the antenna element 609. The signal applied to the first feeding structure 613a may be fed to the antenna element 609 on the air. The permittivity in the area where the signal is transmitted is lowered due to the air layer. Since low permittivity reduces antenna characteristic changes according to frequency changes, the stacked structure including the air layer may provide stable frequency characteristics in broadband. Although not illustrated in FIG. 6A, a signal corresponding to another polarization may be transmitted to the antenna element 609 through the second feeding structure 613b.

Although FIG. 6B illustrates that the connecting structure is disposed on the same surface of the metal pattern of the divider and the dielectric, the embodiments of the disclosure are not limited thereto. According to another embodiment, the connecting structure may be disposed on a surface different from a surface of a dielectric on which a metal pattern of a divider is disposed. Hereinafter, with reference to FIG. 6B, a cross-section of the sub-array module in which the connecting structure is disposed on a different surface from the divider will be described.

Referring to FIG. 6B, the electronic device may include a metal plate 621. The metal plate 621 may provide a ground for the sub-array. A dielectric 623 may be disposed on one surface of the metal plate 621.

The dielectric 623 may include a coupling part. The coupling part of the dielectric 623 may be coupled to the one surface of the metal plate 621. The shape of the coupling part of the dielectric 623 may include a structure for supporting the dielectric 623 from the metal plate 621. The substrate part of the dielectric 623 may forms a gap 635 with the metal plate 621, through the coupling part of the dielectric 623.

The dielectric 623 may include a substrate part. The substrate part of the dielectric 623 refers to an area including a surface on which a transmission line (not shown), a divider 625 and a connecting structure 627 may be disposed. The shape of the dielectric 623 may include a plate-shaped structure. According to an embodiment, the divider 625, the first feeding structure 633a, and the second feeding structure 633b may be disposed along one surface of the dielectric 623. However, the connecting structure 627 may be disposed on a surface different from one surface of the dielectric 623. For example, the connecting structure 627 may be disposed on an opposite surface of one surface of the dielectric 623. Since the branch of the divider 625 and the connecting structure 627 are disposed on different surfaces, the connecting structure 627 may be connected to the branch of the divider 625 through a via.

The dielectric 623 may include a support part 631a, a support part 631b, and a support part 631c. The shapes of the support part 631a, the support part 631b, and the support part 631c may include a structure for supporting the antenna element 629. The dielectric 623 may perform not only a role of an antenna substrate but also a role of a support of the antenna element 629.

The dielectric 623 may include one or more protrusion parts. One or more protrusion parts may be formed at a position higher than the substrate part of the dielectric 623 so that power feeding to the antenna element 629 is performed at a close distance with respect to the metal plate 621. Since the first feeding structure 633a and the second feeding structure 633b are disposed along one surface of the dielectric 623, the feeding position of the first feeding structure 633a and the feeding position of the second feeding structure 633b may be closer to the antenna element 629. Accordingly, the gain of the sub-array module increases.

The signal fed to the connecting structure 627 through the divider 625 may be transmitted to the antenna element 629 through the first feeding structure 633a. For electrical connection between the connecting structure 627 and the first feeding structure 633a, a vertical via may be used. The connecting structure 627 may feed a signal to the first feeding structure 633a disposed on the opposite surface through the vertical via. According to an embodiment, a gap exists between the first feeding structure 633a and the antenna element 629. The signal applied to the first feeding structure 633a may be fed to the antenna element 629 on the air. The permittivity in the area where the signal is transmitted is lowered due to the air layer. Since low permittivity reduces antenna characteristic changes according to frequency changes, the stacked structure including the air layer may provide stable frequency characteristics in broadband. Although not illustrated in FIG. 6B, a signal corresponding to another polarization may be transmitted to the antenna element 629 through the second feeding structure 633b.

Although FIGS. 6A and 6B illustrate that divider and feeding structures are disposed on a surface of a dielectric facing the metal plate, embodiments of the disclosure are not limited thereto. Hereinafter, in FIGS. 6C and 6D, a cross-section of a sub-array module in which the divider and feeding structures are disposed on a surface different from the surface facing the metal plate will be described.

Referring to FIG. 6C, the electronic device may include a metal plate 641. The metal plate 641 may provide a ground for the sub-array. A dielectric 643 may be disposed on one surface of the metal plate 641.

The dielectric 643 may include a coupling part. The coupling part of the dielectric 643 may be coupled to the one surface of the metal plate 641. The shape of the coupling part of the dielectric 643 may include a structure for supporting the dielectric 643 from the metal plate 641. The substrate part of the dielectric 643 may form a gap 655 with a metal plate 641 through the coupling part of the dielectric 643.

The dielectric 643 may include a substrate part. The substrate part of the dielectric 643 refers to an area including a surface on which a transmission line (not shown), a divider 645, and a connecting structure 647 may be disposed. The shape of the dielectric 643 may include a plate-shaped structure. According to an embodiment, the divider 645, the connecting structure 647, the first feeding structure 653a, and the second feeding structure 653b may be disposed along one surface of the dielectric 643.

The dielectric 643 may include a support part 651a, a support part 651b, and a support part 651c. The shapes of the support part 651a, the support part 651b, and the support part 651c may include a structure for supporting the antenna element 649. The dielectric 643 may perform not only the role of the antenna substrate but also the role of the support of the antenna element 649.

The dielectric 643 may include one or more protrusion parts. One or more protrusion parts may be formed at a position higher than the substrate part of the dielectric 643 so that power feeding to the antenna element 649 is performed at a close distance with respect to the metal plate 641. Since the first feeding structure 653a and the second feeding structure 653b are disposed along one surface of the dielectric 643, the feeding position of the first feeding structure 653a and the feeding position of the second feeding structure 653b may be closer to the antenna element 649. Accordingly, the gain of the sub-array module increases.

The signal fed to the connecting structure 647 through the divider 645 may be transmitted to the antenna element 649 through the first feeding structure 653a. According to an embodiment, a gap exists between the first feeding structure 653a and the antenna element 649. The signal applied to the first feeding structure 653a may be fed to the antenna element 649 on the air. The permittivity in the area where the signal is transmitted is lowered due to the air layer. Since low permittivity reduces antenna characteristic changes according to frequency changes, the stacked structure including the air layer may provide stable frequency characteristics in broadband. Although not illustrated in FIG. 6C, a signal corresponding to another polarization may be transmitted to the antenna element 649 through the second feeding structure 653b.

As illustrated in FIG. 6B, the connecting structure may be disposed on a surface of the dielectric substrate opposite to a surface on which the divider and the feeding structure are disposed. Hereinafter, in FIG. 6D, a cross-section of a sub-array module in which the connecting structure is disposed on a different surface from the divider will be described.

Referring to FIG. 6D, the electronic device may include a metal plate 661. The metal plate 661 may provide a ground for the sub-array. A dielectric 663 may be disposed on one surface of the metal plate 661.

The dielectric 663 may include a coupling part. The coupling part of the dielectric 663 may be coupled to the one surface of the metal plate 661. The shape of the coupling part of the dielectric 663 may include a structure for supporting the dielectric 663 from the metal plate 661. The substrate part of the dielectric 663 may form a gap 675 with the metal plate 661, through the coupling part of the dielectric 663.

The dielectric 663 may include a substrate part. The substrate part of the dielectric 663 refers to an area including a surface on which a transmission line (not shown), a divider 665, and a connecting structure 667 may be disposed. The shape of the dielectric 663 may include a plate-shaped structure. According to an embodiment, the divider 665, the first feeding structure 673a, and the second feeding structure 673b may be disposed along one surface of the dielectric 663. However, the connecting structure 667 may be disposed on a surface different from one surface of the dielectric 663. For example, the connecting structure 667 may be disposed on an opposite surface of one surface of the dielectric 663. Since the branch of the divider 665 and the connecting structure 667 are disposed on different surfaces, the connecting structure 667 may be connected to the branch of the divider 665 through a via.

The dielectric 663 may include a support part 671a, a support part 671b, and a support part 671c. The shapes of the support part 671a, the support part 671b, and the support part 671c may include a structure for supporting the antenna element 669. The dielectric 663 may perform not only the role of the antenna substrate but also the role of the support of the antenna element 669.

The dielectric 663 may include one or more protrusion parts. One or more protrusion parts may be formed at a position higher than the substrate part of the dielectric 663 so that power feeding to the antenna element 669 is performed at a close distance with respect to the metal plate 661. Since the first feeding structure 673a and the second feeding structure 673b are disposed along one surface of the dielectric 663, the feeding position of the first feeding structure 673a and the feeding position of the second feeding structure 673b may be closer to the antenna element 669. Accordingly, the gain of the sub-array module increases.

The signal fed to the connecting structure 667 through the divider 665 may be transmitted to the antenna element 669 through the first feeding structure 673a. For electrical connection between the connecting structure 667 and the first feeding structure 673a, vertical vias may be used. The connecting structure 667 may feed a signal to the first feeding structure 673a disposed on the opposite surface through the vertical via. According to an embodiment, a gap exists between the first feeding structure 673a and the antenna element 669. The signal applied to the first feeding structure 673a may be fed to the antenna element 669 on the air. The permittivity in the area where the signal is transmitted is lowered due to the air layer. Since low permittivity reduces antenna characteristic changes according to frequency changes, the stacked structure including the air layer may provide stable frequency characteristics in broadband. Although not illustrated in FIG. 6D, a signal corresponding to another polarization may be transmitted to the antenna element 669 through the second feeding structure 673b.

As described with reference to FIGS. 5, 6A, 6B, 6C, and 6D, embodiments of the disclosure may provide a matching network for the antenna element through an additional structure disposed between the feeding part of the antenna element and the divider. According to embodiments, sub-array modules disposed on PCB or dielectric (e.g., plastic) substrate enable impedance matching in antenna element units through additional structures mounted on one surface. Since non-linearity is supplemented by reducing the deviation between the antenna elements in the sub-arrays, the effect of the grating lobe may be reduced.

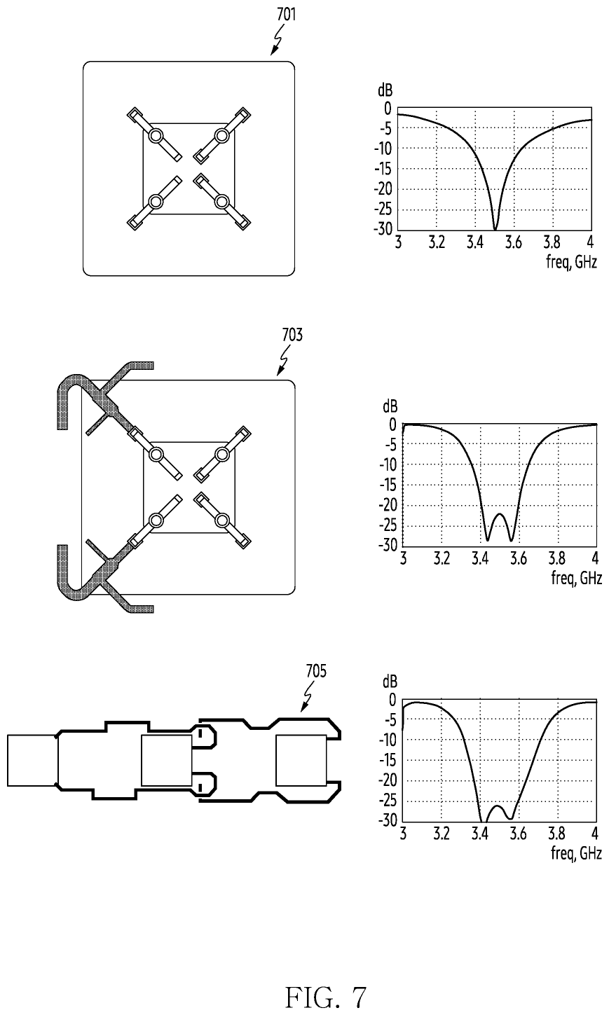

FIG. 7 illustrates an example of a design procedure of a sub-array including an antenna element unit according to an embodiment of the disclosure.

Referring to FIG. 7, in operation 701, feeding structures may be coupled to the antenna element. In operation 703, a connecting structure may be coupled to at least a part of the feeding structures of the antenna element. In operation 705, the connecting structure for each antenna element in the subarray may be connected to the branch of the divider. N branches (N is an integer of 2 or more) of the divider may be respectively connected to N antenna elements. The connecting structure may electrically connect the branch of the divider and the feeding structure. One or more connecting structures per antenna element may be combined. According to an embodiment, connecting structures may be formed so that matching of a specified threshold value (e.g., −20 dB) or less is performed. The shape and function of the connecting structure are described in detail with reference to FIG. 9.

The existing subarray was manufactured through the procedures of antenna element design, divider phase design, divider phase design inspection, and impedance matching. According to embodiments, since the connection structure for impedance matching of the antenna element unit is connected to the antenna element before coupling with the divider, phase design and inspection of the divider may be omitted. Impedance matching is not performed after the antenna element and the divider are combined, but impedance matching is performed in units of antenna elements before the antenna element is combined with the divider. Accordingly, non-linearity of frequency-related characteristics between antenna elements in the same sub-array is reduced. Since the reduction in non-linearity reduces the distortion of the phase or magnitude of radiated signal, the problem due to the grating lobe may be improved. That is, since the antenna reactance is sufficiently removed from each of all antenna elements, linearity is increased and the problem due to the grating lobe is reduced. The sub-array module according to embodiments may provide a sufficient steering range even in broadband.

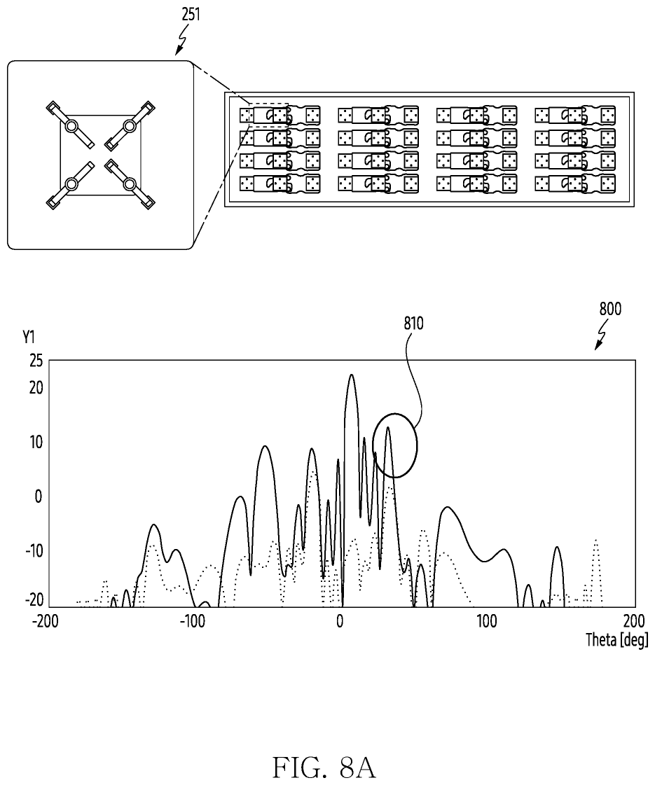

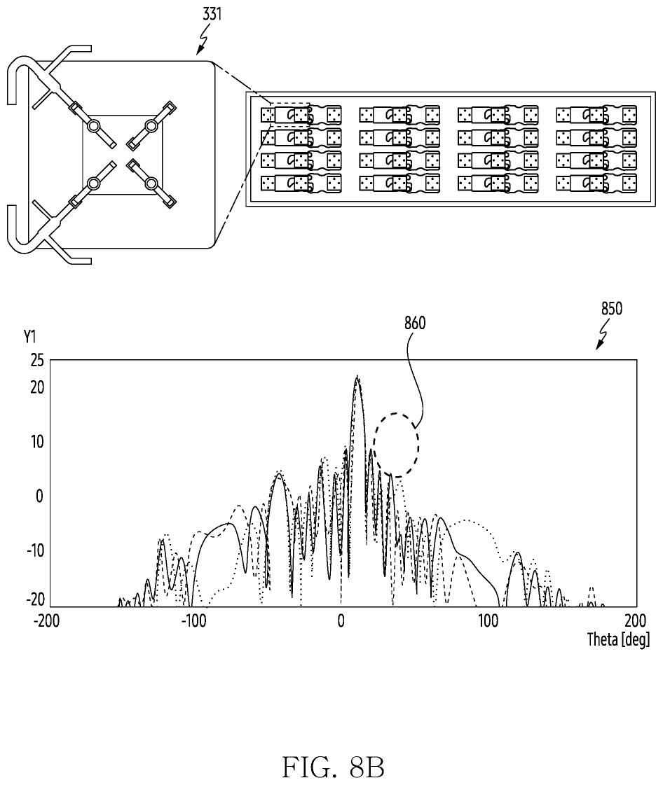

FIGS. 8A and 8B illustrate removal performance of the grating lobe of the sub-array including the antenna element unit according to embodiments of the disclosure.

Referring to FIG. 8A, a graph 800 shows a gain for each radiation angle of an MMU device including an antenna element-based subarray. A horizontal axis of the graph 800 represents a radiation angle (unit: degree) and a vertical axis of the graph 850 represents a gain (unit: dB). Referring to the graph 800, a grating lobe 810 adjacent to the main lobe is generated.

Referring to FIG. 8B, a graph 850 shows a gain for each radiation angle of an MMU device including an antenna element unit-based subarray. A horizontal axis of the graph 850 represents a radiation angle (unit: degree), and a vertical axis of the graph 850 represents a gain (unit: dB). Referring to the graph 850, the removal 860 of the grating lobe adjacent to the main lobe is identified.

FIG. 9 illustrates shapes of a connecting structure of an antenna element unit according to an embodiment of the disclosure.

Referring to FIG. 9, the antenna element unit 331 described in FIGS. 3 to 8 may include a first connecting structure for first polarization and a second connecting structure for second polarization. Hereinafter, the description of the connecting structure can be applied to both the first connecting structure and the second connecting structure. According to an embodiment, the connecting structure of the antenna element unit 331 may include a connecting part, a linear part, a protrusion part, and one or more stubs. Hereinafter, the description of the components of the connecting structure applies not only to the antenna element unit 331 but also to the antenna element unit 910 and the antenna element unit 920 and the antenna element unit 930, the antenna element unit 940, and the antenna element unit 950 described later.

The connecting part of the antenna element unit 331 may transmit an RF signal to the linear part from the branch of the divider. The connecting part may have a shape vent bent toward a point of the linear part from the outside. That is, the connecting part may have a shape bent with respect to the direction of the linear part.

The linear part of the antenna element unit 331 may transmit an RF signal to the feeding structure of the antenna element. The linear part may have a shape of a line facing a specific direction (hereinafter, a line direction). Here, the line direction may be determined according to the polarization of the radiation signal. For example, as illustrated in FIG. 9, the line direction may be a (+)45 degree direction or a (−)45 degree direction.

The protrusion part of the antenna element unit 331 may be disposed opposite to the feeding direction of the linear part based on the point at which the linear part and the connecting part are coupled. According to an embodiment, the protrusion part may have a shape bent with respect to a line direction of the linear part. Although not illustrated in FIG. 9, according to another embodiment, the protrusion part may have a shape in which the linear part is extended based on a line direction of the linear part. The protrusion part may be used to adjust the characteristic impedance of the antenna end. The arrangement of the protrusion part may function as a capacitor or an inductor for impedance matching.

The stubs of the antenna element unit 331 may be disposed in parallel in the linear part. Although FIG. 9 illustrates an example in which one stub is disposed in parallel at a position opposite to a direction of an input unit with respect to a line direction, embodiments of the disclosure are not limited thereto. According to another embodiment, a plurality of stubs may be arranged in parallel. According to another embodiment, a plurality of stubs may be disposed at different positions based on the line direction. The stub may be used to adjust the characteristic impedance of the antenna end. The arrangement of the stub may function as a capacitor or an inductor for impedance matching.

The shape of the connecting structure may be determined for the matching network for each antenna element. Accordingly, a shape of a suitable connecting structure may be determined in the design step of the sub-array module. At least a part of the components of the connecting structure may be omitted according to the characteristic impedance of the antenna element. For example, in order to configure the required matching circuit, at least one of the protrusion part or the stub may be omitted. For another example, a shape different from the shape of the protrusion part of the antenna element unit 331 may be required to configure the required matching circuit. For another example, at least one additional stub may be required in addition to the stub of the antenna element unit 331 in order to configure the required matching circuit.

According to an embodiment, the connecting structure of the antenna element unit 910 may include a connecting part, a linear part, and a protrusion part. Unlike the antenna element unit 331, the antenna element unit 910 may not include a stub.

According to an embodiment, the connecting structure of the antenna element unit 920 may include a connecting part, a linear part, and two stubs. Unlike the antenna element unit 331, the antenna element unit 920 may not include a protrusion part. Instead, the antenna element unit 920 may include two stubs.

According to an embodiment, the connecting structure of the antenna element unit 930 may include a connecting part, a linear part, and a stub. Unlike the antenna element unit 331, the antenna element unit 930 may not include a protrusion part. In addition, the antenna element unit 930 may include a stub different from a stub of the antenna element unit 331. The position, thickness, and length are different from the position, thickness, and length of the antenna element unit 930, respectively.

According to an embodiment, the connecting structure of the antenna element unit 940 may include a connecting part and a linear part. Unlike the antenna element unit 331, the antenna element unit 940 may not include a stub and protrusion part.

According to an embodiment, the connecting structure of the antenna element unit 950 may include a connecting part, a linear part, and two stubs. Unlike the antenna element unit 331, the antenna element unit 950 may not include a protrusion part. The antenna element unit 950 may include two stubs disposed in both directions with respect to the line direction.

The examples shown in FIG. 9 are exemplary, and the connecting structure having a shape using the technical principles described in FIG. 9 may also be understood as an embodiment of the disclosure.

The sub-array may include the antenna element units described above. According to an embodiment, the antenna element units of the sub-array may have the same shape. According to another embodiment, shapes of antenna element units of the sub-array may be different. According to still another embodiment, at least a part of the antenna element units of the sub-array may have the same shape, and at least a part of the other may have a different shape.

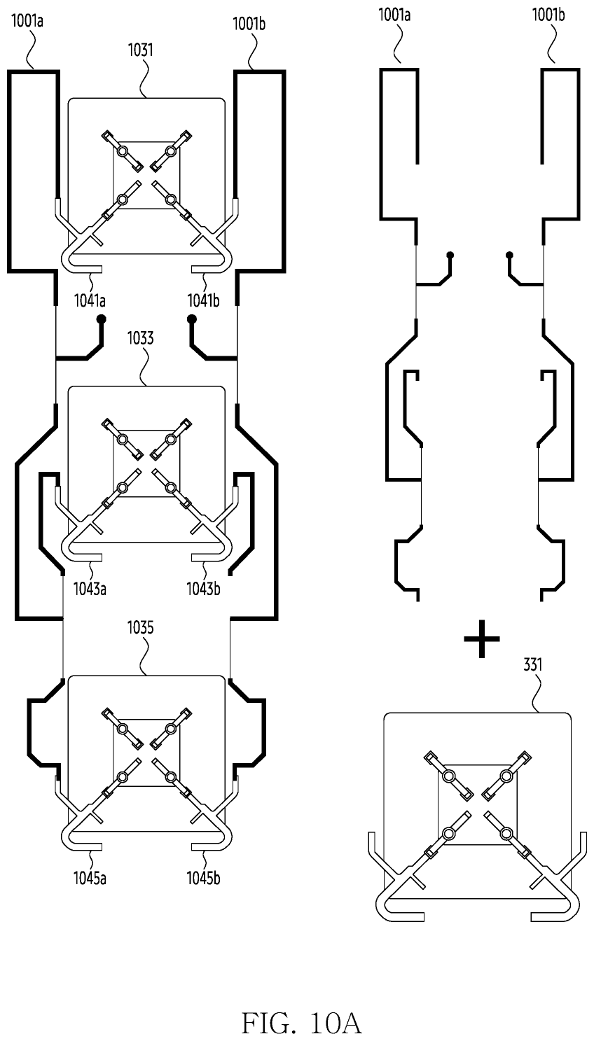

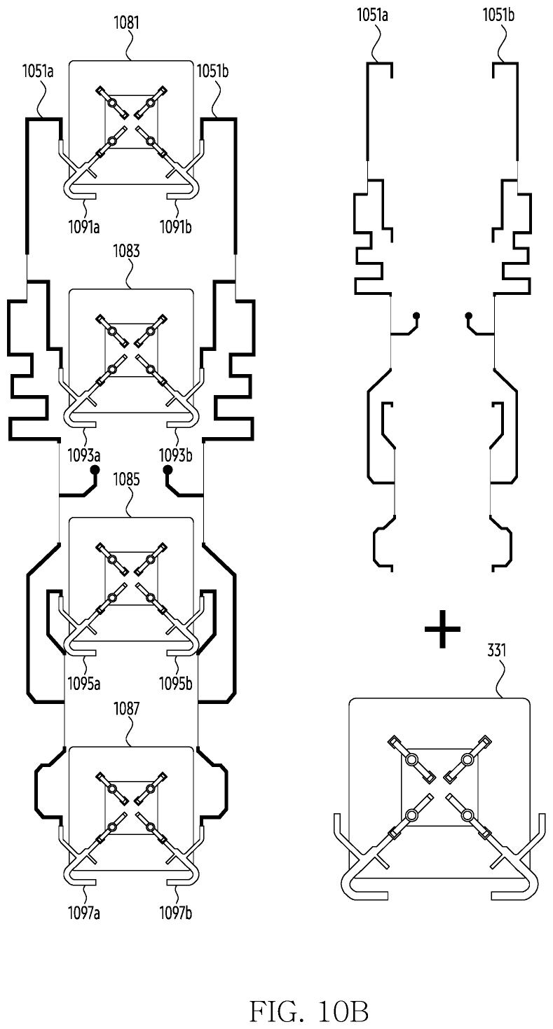

FIGS. 10A and 10B illustrate examples of sub-arrays including antenna element units according to embodiments of the disclosure.

Referring to FIG. 10A, the sub-array may be 3×1 sub-array. The sub-array may include three antenna element units. The sub-array may include three antenna element units. The sub-array may include a first antenna element unit, a second antenna element unit, and a third antenna element unit. The first antenna element unit may include a first antenna element 1031, a first connecting structure 1041a, and a second connecting structure 1041b. The second antenna element unit may include a second antenna element 1033, a third connecting structure 1043a, and a fourth connecting structure 1043b. The third antenna element unit may include a third antenna element 1035, a fifth connecting structure 1045a, and a sixth connecting structure 1045b.

The sub-array may include two devices. The two dividers may include a first divider 1001a for the first polarization and a second divider 1001b for the second polarization. The first divider 1001a may include three branches. The second divider 1001b may include three branches.

Referring to FIG. 10B, the sub-array may be 4×1 sub-array. The sub-array may include four antenna element units and two dividers.

The sub-array may include four antenna element units. The sub-array may include a first antenna element unit, a second antenna element unit, a third antenna element unit, and a fourth antenna element unit. The first antenna element unit may include a first antenna element 1081, a first connecting structure 1091a, and a second connecting structure 1091b. The second antenna element unit may include a second antenna element 1083, a third connecting structure 1093a, and a fourth connecting structure 1093b. The third antenna element unit may include a third antenna element 1085, a fifth connecting structure 1095a, and a sixth connecting structure 1095b. The fourth antenna element unit may include a fourth antenna element 1087, a seventh connecting structure 1097a, and an eighth connecting structure 1097b.

The two dividers may include a first divider 1051a for the first polarization and a second divider 1051b for the second polarization. The first divider 1051a may include four branches. The second divider 1051b may include four branches.

Referring to FIGS. 10A and 10B, the first antenna element unit 331 of FIG. 3 is illustrated as the shape of the antenna element unit, but the embodiments of this disclosure are not limited thereto. At least one of the antenna element units illustrated in FIG. 9 may replace the first antenna element unit 331.

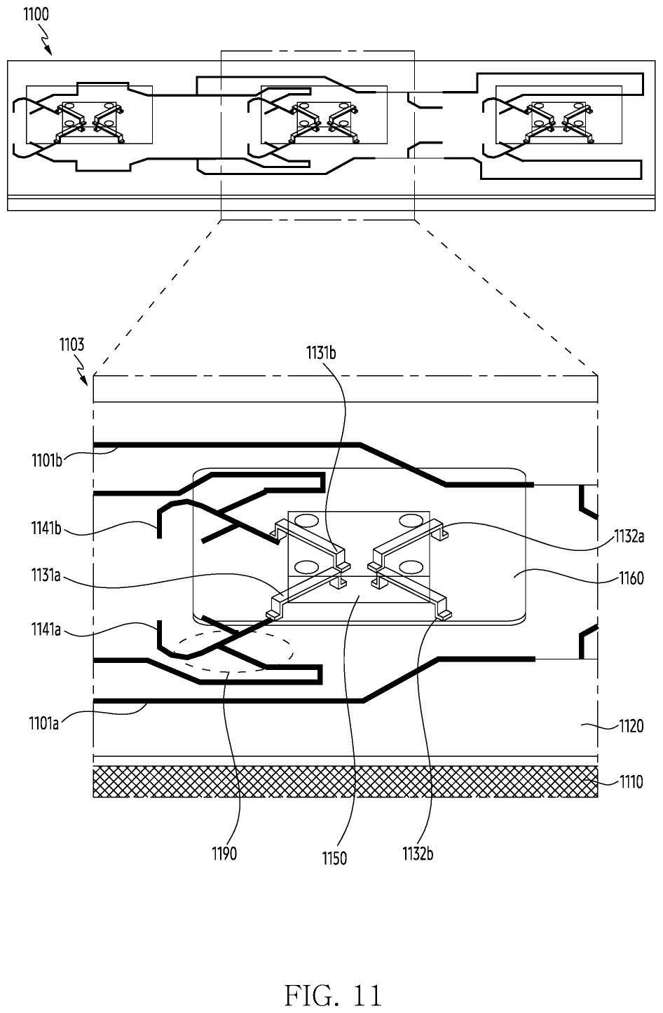

FIG. 11 illustrates an example of a sub-array module including antenna element units according to an embodiment of the disclosure.

Referring to FIG. 11, a perspective view 1100 illustrates a sub-array module including antenna element units according to embodiments. A detailed structure of the second antenna element unit of the sub-array module is illustrated through a perspective view 1103.

The sub-array module may include a metal plate 1110. The sub-array module may include an antenna substrate 1120. The antenna substrate 1120 may be disposed on one surface of the metal plate 1110. For example, the stacked structure of the sub-array module may be the stacked structure of FIG. 5.

The sub-array module may include a first divider 1101a and a second divider 1101b. A metal pattern may be formed on one surface of the antenna substrate 1120. The metal pattern may include a first divider 1101a. The metal pattern may include a second divider 1101b. The first divider 1101a may be used to feed a signal for the first polarization to each antenna element (e.g., the antenna element 1160). The second divider 1101b may be used to feed a signal for the second polarization to each antenna element (e.g., the antenna element 1160).

The sub-array module may include an antenna element unit. The antenna element unit may include an antenna element 1160. The antenna element 1160 may refer to a radiator. For example, the antenna element 1160 may include a radiation patch. Although the rectangular radiation patch is illustrated in FIG. 3 to FIG. 11, the embodiments of the disclosure are not limited thereto. According to another embodiment, the shape of the radiation patch may be a polygon such as a hexagon or an octagon in addition to a square. According to another embodiment, the shape of the radiation patch may be a shape formed of a curve or cut at both ends in addition to a square. Furthermore, according to an additional embodiment, some areas of the surface of the radiation patch may be removed to improve the performance of the cross-polarization ratio (CPR).

The antenna element unit may include a first feeding structure 1131a. The antenna element unit may include a second feeding structure 1131b. The antenna element unit may include a third feeding structure 1132a. The antenna element unit may include a fourth feeding structure 1132b. The antenna element unit may include a support structure 1150. The first feeding structure 1131a, the second feeding structure 1131b, the third feeding structure 1132a, and the fourth feeding structure 1132b may be coupled to the support structure 1150. The support structure 1150 may be coupled to the antenna element 1160. The first feeding structure 1131a and the third feeding structure 1132a may be disposed to face each other. The second feeding structure 1131b and the fourth feeding structure 1132b may be disposed to face each other. Each feeding structure may support the antenna element 1160 through the support structure 1150.

The antenna element unit may include a first connecting structure 1141a. The first connecting structure 1141a may be coupled to the first feeding structure 1131a. The first connecting structure 1141a may be disposed between the branch of the first divider 1101a and the first feeding structure 1131a. The first connecting structure 1141a may electrically connect the branch of the first divider 1101a and the first feeding structure 1131a. The first connecting structure 1141a may be configured to not only provide the electrical connection and but also reduce reactance of characteristic impedance related to the antenna element 1160 viewed from the branch of the first divider 1101a. That is, the shape 1190 of the first connecting structure 1141a may function as a matching network.

The antenna element unit may include a second connecting structure 1141b. The second connecting structure 1141b may be coupled to the second feeding structure 1131b. The second connecting structure 1141b may be disposed between the branch of the second divider 1101b and the second feeding structure 1131b. The second connecting structure 1141b may electrically connect the branch of the second divider 1101b to the second feeding structure 1131b. Like the first connecting structure 1141a, the second connecting structure 1141b may also be configured to reduce the reactance of the characteristic impedance related to the antenna element 1160 viewed from the branch of the second divider 1101b.

CPR is the ratio of the Co-polarization to the Cross-polarization components. For example, the CPR standard is managed at zero degrees of radiation (boresight) and ±60 degrees (Sector edge) in the horizontal radiation pattern of the antenna, and in the case of an array antenna, the CPR is affected by the CPR performance of all single elements. The high CPR indicates that the channel correlation between signals with different polarizations is low. As signals having different polarizations undergo independent channels, polarization diversity may increase. A double polarization antenna is utilized for polarization diversity. Since signal gain can increase as polarization diversity increases, which in turn causes an increase in channel capacity, the independence between the polarization components in the double polarization antenna is used as an indicator of the performance of the double polarization antenna.

In the case of 5G base station antennas compared to 4G base station antennas, the CPR performance becomes more important due to narrow intervals between antennas. In 4G base station that uses a wide beam, the wider the antenna gap, the higher the spatial separation, which improves communication performance, but in 5G base stations that provide services using beams with narrow beam widths and high power density, the antenna gap of the array antennas should be narrowed in order to widen the beamforming area. In other words, technology to prevent CPR degradation is important because interference between antennas increases due to the narrow antenna gap of 5G base station antennas (e.g., gNB of 5G NR, NG-RAN node) compared to 4G base station antennas (e.g., eNB of LTE). Since CPR performance is also proportional to throughput and bit error rate (BER), which are major indicators of communication performance, operators are demanding high CPR to improve 5G communication performance.

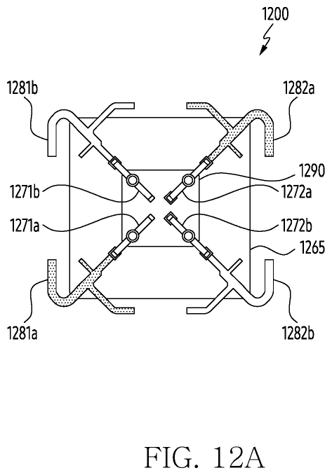

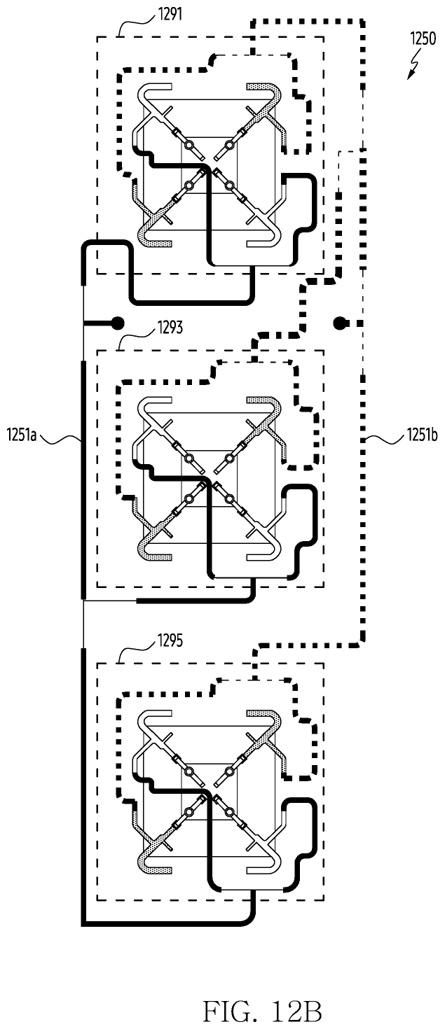

In order to improve the above-described CPR performance, the antenna element unit according to the embodiments may support a 4-port using four signal inputs, not only two signal inputs. Hereinafter, examples of antenna element units for 4-port will be described with reference to FIGS. 12A to 14.

FIG. 12A illustrates an example of an antenna element unit for a 4-port according to an embodiment of the disclosure.

Referring to FIG. 12A, according to embodiments, the antenna element unit 1200 may include an antenna element 1260, a first feeding structure 1271a, a second feeding structure 1271b, a third feeding structure 1272a, a fourth feeding structure 1272b, a first connecting structure 1281a, a second connecting structure 1281b, a third connecting structure 1282a, and a fourth connecting structure 1282b.

The antenna element 1265 may refer to a radiator for radiating a fed signal into the air. According to an embodiment, the antenna element 1265 may include a radiation patch. Although the rectangular radiation patch is illustrated in FIG. 12A, the embodiments of the disclosure are not limited thereto. According to another embodiment, the shape of the radiation patch may be a shape formed of a curve or cut at both ends in addition to a square. Furthermore, according to an additional embodiment, some areas of the surface of the radiation patch may be removed to improve the performance of the cross-polarization ratio (CPR).

The first feeding structure 1271a, the second feeding structure 1271b, the third feeding structure 1272a, and the fourth feeding structure 1272b are components for feeding an applied signal to the antenna element 1265. According to an embodiment, the first feeding structure 1271a and the third feeding structure 1272a may be disposed in a direction of first polarization. According to an embodiment, the second feeding structure 1271b and the fourth feeding structure 1272b may be disposed in the direction of the second polarization.

The first feeding structure 1271a, the second feeding structure 1271b, the third feeding structure 1272a, and the fourth feeding structure 1272b may support the antenna element through the support structure 1290. Each of the first feeding structure 1271a, the second feeding structure 1271b, the third feeding structure 1272a, and the fourth feeding structure 1272b may be coupled to the support structure 1290. On the other hand, unlike shown in FIG. 12A, each feeding structure may be configured to support the antenna element without the support structure 1290.

The first connecting structure 1281a may be connected to the first feeding structure 1271a. The first connecting structure 1281a may be connected to a first divider for first polarization. That is, the first connecting structure 1281a may be disposed between the first feeding structure 1271a and the first divider. The first connecting structure 1281a may be disposed for impedance matching of the antenna element 1265. That is, the first connecting structure 1281a may be configured to reduce the reactance of the characteristic impedance from the branch of the first divider to the antenna element 1265.

The second connecting structure 1281b may be connected to the second feeding structure 1271b. The second connecting structure 1281b may be connected to a second divider for second polarization. That is, the second connecting structure 1281b may be disposed between the second feeding structure 1271b and the second divider. The second connecting structure 1281b may be disposed for impedance matching of the antenna element 1265. That is, the second connecting structure 1281b may be configured to reduce the reactance of the characteristic impedance from the branch of the second divider to the antenna element 1265.

The third connecting structure 1282a may be connected to the third feeding structure 1272a. According to an embodiment, the third connecting structure 1282a may be connected to a first divider for first polarization. That is, the third connecting structure 1282a may be disposed between the third feeding structure 1272a and the first divider. The third connecting structure 1282a may be disposed for impedance matching of the antenna element 1265. The first divider may include two branches for the antenna element 1265. The first divider may have 2N branches for N antenna elements (N is an integer of 2 or more). Signals of two branches may be supplied to each antenna element.

The fourth connecting structure 1282b may be connected to the fourth feeding structure 1272b. The fourth connecting structure 1282b may be connected to a second divider for second polarization. That is, the fourth connecting structure 1282b may be disposed between the fourth feeding structure 1272b and the second divider. The fourth connecting structure 1282b may be disposed for impedance matching of the antenna element 1265. The second divider may include two branches for the antenna element 1265. The second divider may have 2N branches for N antenna elements (N is an integer of 2 or more). Signals of two branches may be supplied to each antenna element.

A total of four connecting structures are disposed for the antenna element 1265. Through four connecting structures and four feeding structures, signals of two branches for each polarization may be supplied to the antenna element 1265. The antenna element 1265 may radiate four input signals.

CPR performance, isolation performance, and reflection performance of the sub-array may be improved, by using different feeding lines for the same polarization. According to an embodiment, the difference between the phase conversion value of the first connecting structure 1281a and the phase conversion value using the third connecting structure 1282a may be substantially 180 degrees. In order to distinguish between a signal fed through the first connecting structure 1281a and a signal fed through the third connecting structure 1282a, the first connecting structure 1281a and the third connecting structure 1282a may be formed such that a phase difference between the same polarization is 180 degrees. In addition, the first polarization signals are orthogonal to the second polarization signals through a phase difference of 180 degrees, thereby improving CPR performance.

According to an embodiment, the difference between the phase conversion value of the second connecting structure 1281b and the phase conversion value using the third connecting structure 1282a may be substantially 180 degrees. In order to distinguish between a signal fed through the second connecting structure 1281b and a signal fed through the fourth connecting structure 1282b, the second connecting structure 1281b and the fourth connecting structure 1282b may be formed such that a phase difference between the same polarizations is 180 degrees. In addition, the signals of the second polarization are orthogonal to the signals of the first polarization through a phase difference of 180 degrees, thereby improving CPR performance.

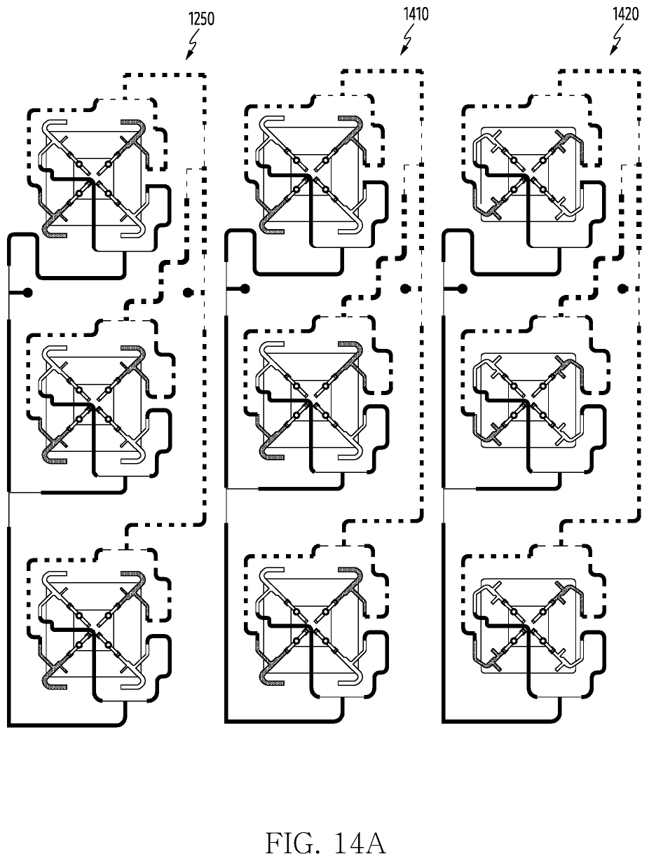

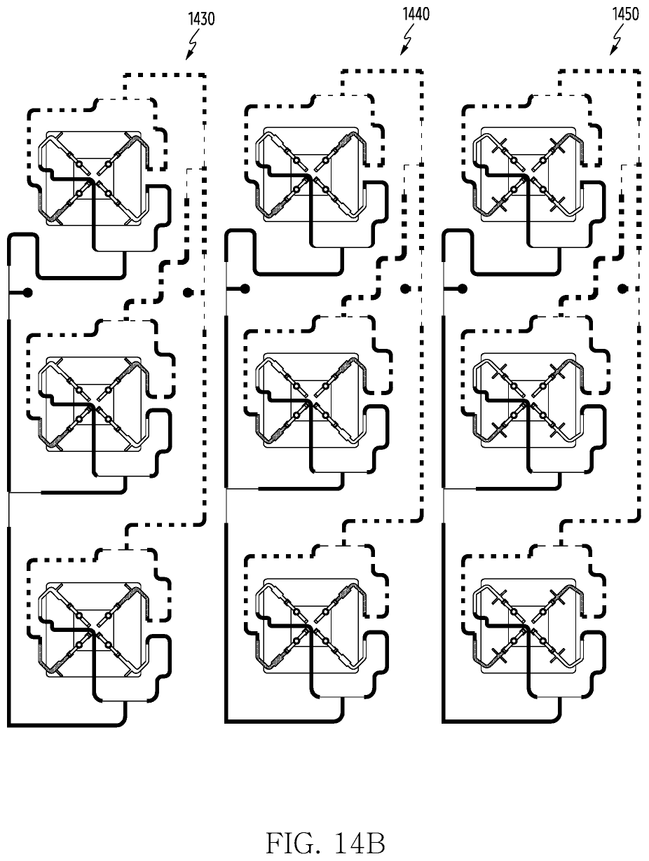

Although the shape of the connecting structure (e.g., the first connecting structure 1281a, the second connecting structure 1281b, the third connecting structure 1282a, and the fourth connecting structure 1282b) for impedance matching is illustrated in FIG. 12A, the embodiments of the disclosure are not limited thereto. The shape of the connecting structure may be changed in various ways if the technical principles using impedance matching are the same. Specific examples of the shape of the connecting structure will be described with reference to FIGS. 14A and 14B.

FIG. 12B illustrates an example 1250 of a sub-array including antenna element units for a 4-port according to an embodiment of the disclosure. Although FIG. 12B illustrates 3×1 sub-array, embodiments of the disclosure are not limited thereto. As another example, the sub-array may be 4×1 sub-array. As still another example, the sub-array may be 3×2 sub-array.

Referring to FIG. 12B, the sub-array may include antenna element units for three 4-ports. An antenna element unit for a 4-port may be referred to as a 4-port based antenna element unit. The sub-array may include a first 4-port based antenna element unit 1291, a second 4-port based antenna element unit 1293, and a third 4-port based antenna element unit 1295. The description of the antenna element unit of FIG. 12A may be applied to each of the antenna element units.

The sub-array may include two dividers. The two dividers may include a first divider 1251a for first polarization and a second divider 1251b for second polarization. The first divider 1251a may include three branches. The second divider 1251b may include three branches.

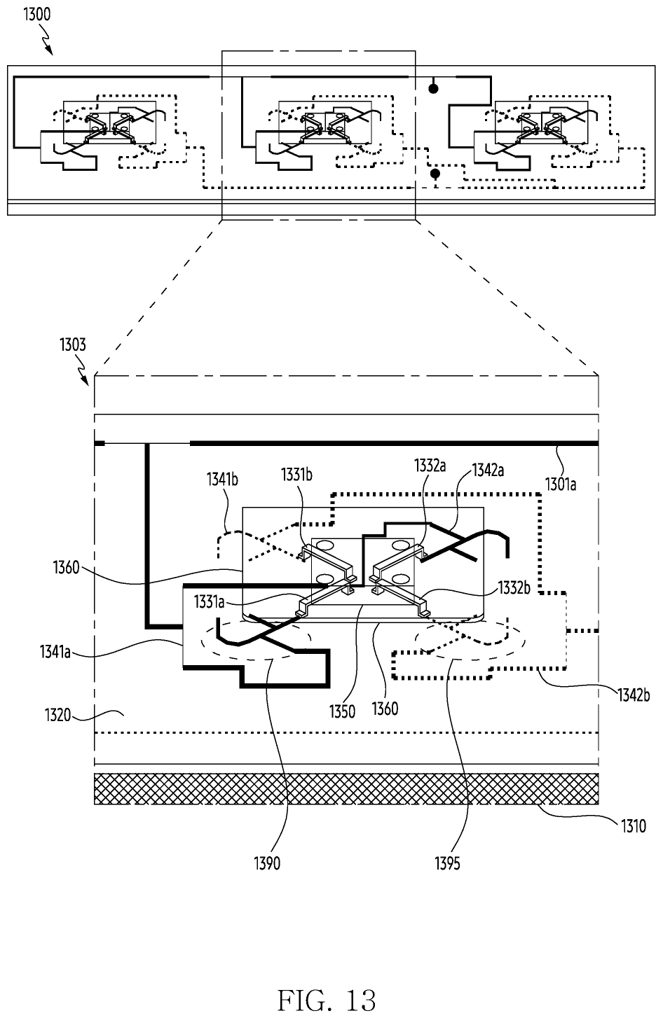

FIG. 13 illustrates an example of a sub-array module including antenna element units for a 4-port according to an embodiment of the disclosure.

Referring to FIG. 13, a perspective view 1300 illustrates a sub-array module including antenna element units according to embodiments. A detailed structure of the second antenna element unit of the sub-array module is illustrated through a perspective view 1303.

The sub-array module may include a metal plate 1310. The sub-array module may include an antenna substrate 1320. An antenna substrate 1320 may be disposed on one surface of the metal plate 1310. For example, the stacked structure of the sub-array module may be the stacked structure of FIG. 5.

The sub-array module may include a first divider 1301a and a second divider 1301b. A metal pattern may be formed on one surface of the antenna substrate 1320. The metal pattern may include the first divider 1301a. The metal pattern may include the second divider 1301b. The first divider 1301a may be used to feed a signal for first polarization to each antenna element (e.g., antenna element 1360). The second divider 1301b may be used to feed a signal for second polarization to each antenna element (e.g., antenna element 1360).

The sub-array module may include an antenna element unit. The antenna element unit may include an antenna element 1360. The antenna element 1360 may refer to a radiator. For example, the antenna element 1360 may include a radiation patch. Although FIGS. 3, 4A, 4B, 5, 6A, 6B, 6C, 6D, 7, 8A, 8B, 9, 10A, 10B, 11, 12A, and 12B illustrate a rectangular radiation patch, the embodiments of the disclosure are not limited thereto. According to another embodiment, the shape of the radiation patch may be a polygon such as a hexagon or an octagon in addition to a square. According to another embodiment, the shape of the radiation patch may be a shape formed of a curve or cut at both ends in addition to a square. Furthermore, according to an additional embodiment, some areas of the surface of the radiation patch may be removed to improve the performance of the cross-polarization ratio (CPR).

The antenna element unit may include a first feeding structure 1331a. The antenna element unit may include a second feeding structure 1331b. The antenna element unit may include a third feeding structure 1332a. The antenna element unit may include a fourth feeding structure 1332b. The antenna element unit may include a support structure 1350. The first feeding structure 1331a, the second feeding structure 1331b, the third feeding structure 1332a, and the fourth feeding structure 1332b may be coupled to the support structure 1350. The support structure 1350 may be coupled to the antenna element 1360. The first feeding structure 1331a and the third feeding structure 1332a may be disposed to face each other. The second feeding structure 1331b and the fourth feeding structure 1332b may be disposed to face each other. Each feeding structure may support the antenna element 1360 through the support structure 1350.

The antenna element unit may include a first connecting structure 1341a. The first connecting structure 1341a may be coupled to the first feeding structure 1331a. The first connecting structure 1341a may be disposed between the branch of the first divider 1301a and the first feeding structure 1331a. The first connecting structure 1341a may electrically connect the branch of the first divider 1301a and the first feeding structure 1331a. The first connecting structure 1341a may be configured to not only the electrical connection but also reduce reactance of characteristic impedance related to the antenna element 1360 viewed from the branch of the first divider 1301a. That is, the shape 1390 of the first connecting structure 1341a may function as a matching network.

The antenna element unit may include a second connecting structure 1341b. The second connecting structure 1341b may be coupled to the second feeding structure 1331b. The second connecting structure 1341b may be disposed between the branch of the second divider 1301b and the second feeding structure 1331b. The second connecting structure 1341b may electrically connect the branch of the second divider 1301b and the second feeding structure 1331b. Like the first connecting structure 1341a, the second connecting structure 1341b may also be configured to reduce the reactance of the characteristic impedance related to the antenna element 1360 viewed from the branch of the second divider 1301b.

The antenna element unit may include a third connecting structure 1342a. The third connecting structure 1342a may be coupled to the third feeding structure 1332a. The third connecting structure 1342a may be disposed between the branch of the first divider 1301a and the third feeding structure 1332a. The third connecting structure 1342a may electrically connect the branch of the first divider 1301a and the third feeding structure 1332a. The third connecting structure 1342a may be configured to reduce reactance of characteristic impedance related to the antenna element 1360 viewed from the branch of the first divider 1301a as well as electrical connection.

The antenna element unit may include a fourth connecting structure 1342b. The fourth connecting structure 1342b may be coupled to the fourth feeding structure 1332b. The fourth connecting structure 1342b may be disposed between the branch of the second divider 1301b and the fourth feeding structure 1332b. The fourth connecting structure 1342b may electrically connect the branch of the second divider 1301b and the fourth feeding structure 1332b. Like the third connecting structure 1342a, the fourth connecting structure 1342b may also be configured to reduce the reactance of the characteristic impedance related to the antenna element 1360 viewed from the branch of the second divider 1301b. That is, the shape 1395 of the fourth connecting structure 1342b may function as a matching network.

FIGS. 14A and 14B illustrate examples of a sub-array including antenna element units for 4-ports according to embodiments of the disclosure. FIGS. 14A and 14B illustrate antenna element units and sub-arrays for 4-port to which various examples of the shape of the connecting structure mentioned in FIG. 9 are applied. FIGS. 14A and 14B illustrate 3×1 sub-array, but embodiments of the disclosure are not limited thereto. As another example, the sub-array may be 4×1 sub-array. As still another example, the sub-array may be 3×2 sub-array.

Referring to FIG. 14A, the antenna element unit of the sub-array 1250 may include a first connecting structure for first polarization, a second connecting structure for second polarization, a third connecting structure for first polarization, and a fourth connecting structure for second polarization. Hereinafter, the description of the connecting structure may be applied to all of the first connecting structure, the second connecting structure, the third connecting structure, and the fourth connecting structure.

According to an embodiment, the connecting structure of the sub-array 1250 for the 4-port is a component of the connecting structure and may include a connecting part, a linear part, a protrusion part, and one or more stubs. The connecting structure of the sub-array 1250 for the 4-port may correspond to the connecting structure of the first antenna element unit 331 shown in FIGS. 3, 4A, 4B, 5, 6A, 6B, 6C, 6D, 7, 8A, and 8B. However, the antenna element unit 331 may include two connecting structures, but the connecting structure of the sub-array 1250 for the 4-port may include four connecting structures. The connecting structures of the same polarization may be symmetrically disposed with respect to the center of the antenna element.

The shape of the connecting structure may be determined for the matching network for each antenna element. Accordingly, in the design step of the sub-array module, a shape of a suitable connecting structure may be determined. At least a part of the components of the connecting structure may be omitted according to the characteristic impedance of the antenna element. For example, in order to configure the required matching circuit, at least one of the protrusion part or the stub may be omitted.

According to an embodiment, the connecting structure of the sub-array 1410 for the 4-port may include a connecting part, a linear part, and a protrusion part as a component of the connecting structure. The connecting structure of the sub-array 1250 for the 4-port may correspond to the connecting structure of the antenna element unit 910 illustrated in FIG. 9. However, the antenna element unit 910 may include two connecting structures, but the connecting structure of the sub-array 1410 for the 4-port may include four connecting structures. The connecting structures of the same polarization may be symmetrically disposed with respect to the center of the antenna element.

According to an embodiment, the connecting structure of the sub-array 1420 for the 4-port may include a connecting part, a linear part, and two stubs, as a component of the connecting structure. The connecting structure of the sub-array 1420 for the 4-port may correspond to the connecting structure of the antenna element unit 920 illustrated in FIG. 9. However, the antenna element unit 920 may include two connecting structures, but the connecting structure of the sub-array 1420 for the 4-port may include four connecting structures. The connecting structures of the same polarization may be symmetrically disposed with respect to the center of the antenna element.

Referring to FIG. 14B, according to an embodiment, the connecting structure of the sub-array 1430 for the 4-port may include a connecting part, a linear part, and a stub as a component of the connecting structure. The connecting structure of the sub-array 1430 for the 4-port may correspond to the connecting structure of the antenna element unit 930 illustrated in FIG. 9. However, the antenna element unit 930 may include two connecting structures, but the connecting structure of the sub-array 1430 for the 4-port may include four connecting structures. The connecting structures of the same polarization may be symmetrically disposed with respect to the center of the antenna element.

According to an embodiment, the connecting structure of the sub-array 1440 for the 4-port may include a connecting part and a linear part as a component of the connecting structure. The connecting structure of the sub-array 1440 for the 4-port may correspond to the connecting structure of the antenna element unit 940 illustrated in FIG. 9. However, the antenna element unit 940 may include two connecting structures, but the connecting structure of the sub-array 1440 for the 4-port may include four connecting structures. The connecting structures of the same polarization may be symmetrically disposed with respect to the center of the antenna element.

According to an embodiment, the connecting structure of the sub-array 1450 for the 4-port may include a connecting part, a linear part, and two stubs as components of the connecting structure. The connecting structure of the sub-array 1450 for the 4-port may correspond to the connecting structure of the antenna element unit 950 illustrated in FIG. 9. However, the antenna element unit 950 may include two connecting structures, but the connecting structure of the sub-array 1450 for the 4-port may include four connecting structures. The connecting structures of the same polarization may be symmetrically disposed with respect to the center of the antenna element.

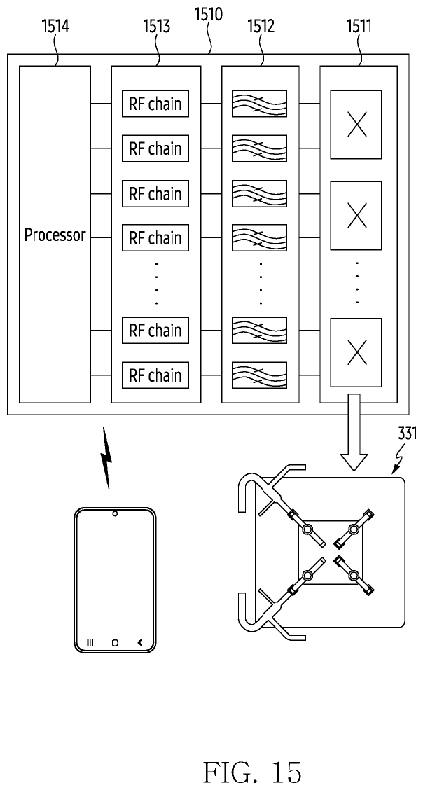

FIG. 15 illustrates a functional configuration of an electronic device including an antenna array having an antenna element unit according to an embodiment of the disclosure. The electronic device 1510 may be the base station 110 or the MMU of the base station 110 of FIG. 1. Meanwhile, unlike the illustration, the disclosure does not exclude that the described antenna structure or the electronic device 1510 including the same may be implemented in the terminal 120 of FIG. 1. Not only the antenna structure itself referred to with reference to FIGS. 1 to 14B, but also an electronic device including the antenna structure is included in embodiments of the disclosure. The electronic device 1510 may include an antenna structure including a decoupling coupler disposed between power dividers electrically connected to the sub-array.

Referring to FIG. 15, a functional configuration of the electronic device 1510 is illustrated. The electronic device 1510 may include an antenna unit 1511, a filter unit 1512, a radio frequency (RF) processing unit 1513, and a controller 1514.

The antenna unit 1511 may include a plurality of antennas. The antenna performs functions for transmitting and receiving signals through a wireless channel. The antenna may include a conductor formed above a substrate (e.g., a PCB or dielectric) or a radiator made of a conductive pattern. The antenna may radiate the up-converted signal on the wireless channel or obtain a signal radiated by another device. Each antenna may be referred to as an antenna element or an antenna element. In some embodiments, the antenna unit 1511 may include an antenna array in which a plurality of antenna elements form an array. The antenna unit 1511 may be electrically connected to the filter unit 1512 through RF signal lines. The antenna unit 1511 may be mounted on a PCB including a plurality of antenna elements. The PCB may include a plurality of RF signal lines connecting each antenna element and a filter of the filter unit 1512. Such RF signals may be referred to as feeding networks. The antenna unit 1511 may provide the received signal to the filter unit 1512 or radiate the signal provided from the filter unit 1512 into the air.

The antenna unit 1511 according to embodiments of the disclosure may include one or more sub-array modules. The sub-array module may include a divider and an antenna element unit. According to embodiments, an additional structure may be disposed between the divider and the feeding portion of the antenna element. As described in FIGS. 1, 2A, 2B, 3, 4A, 4B, 5, 6A, 6B, 6C, 6D, 7, 8A, 8B, 9, 10A, 10B, 11, 12A, 12B, 13, 14A, and 14B, the antenna element unit may include an antenna element, a first feeding structure for first polarization, a second feeding structure for second polarization, a first connecting structure for connecting the first feeding structure to the divider branch, and a second connecting structure for connecting the first feeding structure to the second divider branch. The first divider is a metal pattern for the first polarization, and the first divider has a branch for each antenna element of the subarray. The second divider is a metal pattern for second polarization, and the second divider has a branch for each antenna element of the subarray.

An additional structure, that is, a connecting structure, functions as a matching network for antenna elements in each path. Although FIG. 15 illustrates the first antenna element unit 331 of FIG. 3 as an antenna having a decoupling coupler, but the shapes of FIGS. 9, 10A, 10B, 11, 12A, 12B, 13, 14A, and 14B may also be coupled and applied with the description of FIG. 15. In addition, in case of a structure for a matching network for each antenna element, which is disposed between the branch of the divider and the antenna element, the following descriptions may be applied.

The filter unit 1512 may perform filtering to transmit a signal of a desired frequency. The filter unit 1512 may perform a function of selectively identifying a frequency by forming a resonance. The filter unit 1512 may include at least one of a band pass filter, a low pass filter, a high pass filter, or a band reject filter. That is, the filter unit 1512 may include RF circuits for obtaining a signal of a frequency band for transmission or a frequency band for reception. The filter unit 1512 according to various embodiments may electrically connect the antenna unit 1511 and the RF processing unit 1513.

The RF processing unit 1513 may include a plurality of RF paths. The RF path may be a unit of a path through which a signal received through an antenna or a signal radiated through the antenna passes. At least one RF path may be referred to as an RF chain. The RF chain may include a plurality of RF elements. The RF elements may include an amplifier, a mixer, an oscillator, a digital-to-analog converter (DAC), an analog-to-digital converter (ADC), and the like. For example, the RF processing unit 1513 may include an up converter that upwardly converts a digital transmission signal of a baseband into a transmission frequency, and a digital-to-analog converter (DAC) that converts the upwardly converted digital transmission signal into an analog RF transmission signal. The up converter and the DAC form part of the transmission path. The transmission path may further include a power amplifier (PA) or a coupler (or a combiner). Also, for example, the RF processing unit 1513 may include an analog-to-digital converter (ADC) for converting an analog RF reception signal into a digital reception signal and a down converter for converting a digital reception signal into a digital reception signal of a baseband. The ADC and the down converter form part of the reception path. The reception path may further include a low-noise amplifier (LNA) or a coupler (or a divider). RF components of the RF processing unit may be implemented in a PCB. The electronic device 1510 (e.g., a base station) may include a structure stacked in the order of the antenna unit 1511 to the filter unit 1512 to the RF processing unit 1513. The antennas and RF components of the RF processing unit may be implemented on a PCB, and filters may be repeatedly fastened between the PCB and the PCB to form multiple layers.

The controller 1514 may control overall operations of the electronic device 1510. The controller 1514 may include various modules for performing communication. The controller 1514 may include at least one processor such as a modem. The controller 1514 may include modules for digital signal processing. For example, the controller 1514 may include a modem. During data transmission, the controller 1514 generates complex symbols by encoding and modulating a transmission bit string. In addition, for example, when receiving data, the controller 1514 restores the received bit string through demodulation and decoding of the baseband signal. The controller 1514 may perform functions of a protocol stack required by a communication standard.

Referring to FIG. 15, a functional configuration of the electronic device 1510 is described as an equipment in which the antenna structure of the disclosure may be utilized. However, the example shown in FIG. 15 is an example configuration for utilizing the antenna structure according to the various embodiments of disclosure described in FIGS. 1, 2A, 2B, 3, 4A, 4B, 5, 6A, 6B, 6C, 6D, 7, 8A, 8B, 9, 10A, 10B, 11, 12A, 12B, 13, 14A, and 14B, and the embodiments of disclosure are not limited to the components of the equipment shown in FIG. 15. Accordingly, an antenna module including an antenna structure, communication equipment of other configurations, and an antenna structure itself may also be understood as an embodiment of the disclosure.

Embodiments of the disclosure propose a structure of an antenna array for improving a synthesis pattern of the antenna array. An additional structure may be disposed between each antenna element and a branch of the divider. The shape of the additional structure may be used for impedance matching for each corresponding antenna element. In other words, the additional structure coupled to the antenna element may function as a matching network.

Distortion between antenna elements in the sub-array is reduced through impedance matching in antenna element units. The reduced distortion reduces the non-linearity of the frequency characteristics. For example, the reduced distortion causes the signal magnitude between the antenna elements in the subarray to be equal or close to the same value over the frequency range of the broadband. In addition, for example, reduced distortion provides a linear phase difference between antenna elements in the subarray over the frequency range of the broadband. This reduction in non-linearity removes the grating lobe in broadband. The antenna element unit according to embodiments of the disclosure may remove the grating lobe in broadband without increasing the overall size or reducing the gain, through a matching network added to the antenna element itself. Therefore, an antenna array including an antenna element unit according to embodiments of the disclosure may provide a high peak gain and a wide steering range in broadband.

According to an embodiment, an electronic device including a sub-array module may comprise an antenna substrate, a plurality of antenna element units, a first divider for a first polarization, and a second divider for a second polarization. Each antenna element unit of the plurality of antenna element units may include an antenna element for an emission of a signal, a first feeding structure for the first polarization, a second feeding structure for the second polarization, a first connecting structure for branching the first feeding structure and the first divider, and a second connecting structure for branching the second feeding structure and the second divider.

According to an embodiment, the first connecting structure may be configured to reduce a reactance of a characteristic impedance from a branch of the first divider to the antenna element. The second connecting structure may be configured to reduce a reactance of a characteristic impedance from a branch of the second divider to the antenna element.

According to an embodiment, the first feeding structure and the second feeding structure may be disposed to support a corresponding antenna element.

According to an embodiment, a shape of the first connecting structure may include a first connecting part coupled to the branch of the first divider and a first linear part for feeding to the first feeding structure. A shape of the second connecting structure may include a second connecting part coupled to the branch of the second divider and a second linear part for feeding to the second feeding structure.

According to an embodiment, the shape of the first connecting structure may further include a first protrusion part having a shape bent with respect to the second linear part. The shape of the second connecting structure further may include a second protrusion having a shape bent with respect to the second linear part.

According to an embodiment, the shape of the first connecting structure may include at least one stub disposed based on a direction perpendicular to a feeding direction from the first connecting structure to the first feeding structure. The shape of the second connecting structure may include at least one stub disposed based on a direction perpendicular to a feeding direction from the second connecting structure to the second feeding structure.

According to an embodiment, the antenna element unit may further include a third connecting structure for branching the first divider, a fourth connecting structure for branching the second divider, a third feeding structure connected to the third connecting structure, a fourth feeding structure connected to the fourth connecting structure. The first feeding structure and the third feeding structure may be disposed based on a direction of the first polarization. The second feeding structure and the fourth feeding structure may be disposed based on a direction of the second polarization.

According to an embodiment, another antenna element unit among the plurality of antenna element units may include another antenna element, a fifth feeding structure for another branch of the first divider. The other antenna element unit may include a sixth feeding structure for another branch of the second divider. The other antenna element unit may a fifth connecting structure for branching the fifth feeding structure and the first divider, and a sixth connecting structure for branching the fifth feeding structure and the second divider. The fifth feeding structure and the sixth feeding structure may be configured to reduce a reactance of the other antenna element.

According to an embodiment, the electronic device may include a metal plate for ground. The antenna substrate may be disposed on one surface of the metal plate.

According to an embodiment, the antenna substrate may be formed by at least a part of a dielectric. A shape of the dielectric may include at least one support part for supporting the antenna element for each of the plurality of antenna element units.

According to an embodiment, an electronic device comprises a processor, RF processing chains, a filter module, an antenna array module including a plurality of sub-arrays. Each sub-array of the plurality of sub-arrays may include an antenna substrate, a plurality of antenna element units, a first divider for a first polarization, a second divider for a second polarization. Each antenna element unit of the plurality of antenna element units may include an antenna element for an emission of a signal, a first feeding structure for the first polarization, a second feeding structure for the second polarization, a first connecting structure for branching the first feeding structure and the first divider, a second connecting structure for branching the second feeding structure and the second divider.

According to an embodiment, the first connecting structure may be configured to reduce a reactance of a characteristic impedance from a branch of the first divider to the antenna element. The second connecting structure may be configured to reduce a reactance of a characteristic impedance from a branch of the second divider to the antenna element.

According to an embodiment, the first feeding structure and the second feeding structure may be disposed to support a corresponding antenna element.

According to an embodiment, a shape of the first connecting structure may include a first connecting part coupled to the branch of the first divider and a first linear part for feeding to the first feeding structure. A shape of the second connecting structure may include a second connecting part coupled to the branch of the second divider and a second linear part for feeding to the second feeding structure.

According to an embodiment, the shape of the first connecting structure may further include a first protrusion part having a shape bent with respect to the second linear part. The shape of the second connecting structure further may include a second protrusion having a shape bent with respect to the second linear part.

According to an embodiment, the shape of the first connecting structure may include at least one stub disposed based on a direction perpendicular to a feeding direction from the first connecting structure to the first feeding structure. The shape of the second connecting structure may include at least one stub disposed based on a direction perpendicular to a feeding direction from the second connecting structure to the second feeding structure.

According to an embodiment, the antenna element unit may further include a third connecting structure for branching the first divider, a fourth connecting structure for branching the second divider, a third feeding structure connected to the third connecting structure, a fourth feeding structure connected to the fourth connecting structure. The first feeding structure and the third feeding structure may be disposed based on a direction of the first polarization. The second feeding structure and the fourth feeding structure may be disposed based on a direction of the second polarization.

According to an embodiment, another antenna element unit among the plurality of antenna element units may include another antenna element, a fifth feeding structure for another branch of the first divider. The other antenna element unit may include a sixth feeding structure for another branch of the second divider. The other antenna element unit may a fifth connecting structure for branching the fifth feeding structure and the first divider, and a sixth connecting structure for branching the fifth feeding structure and the second divider. The fifth feeding structure and the sixth feeding structure may be configured to reduce a reactance of the other antenna element.

According to an embodiment, the electronic device may include a metal plate for ground. The antenna substrate may be disposed on one surface of the metal plate.

According to an embodiment, the antenna substrate may be formed by at least a part of a dielectric. A shape of the dielectric may include at least one support part for supporting the antenna element for each of the plurality of antenna element units.

According to an embodiment, a shape of the first connecting structure includes at least one stub disposed based on a direction perpendicular to a feeding direction from the first connecting structure to the first feeding structure. The stub configured to adjust a characteristic impedance of an antenna end.

According to an embodiment, an arrangement of the stub functions as a capacitor.

Methods according to the embodiments described in the claims or the specification of the disclosure may be implemented in the form of hardware, software, or a combination of hardware and software.

When implemented as software, a computer-readable storage medium storing one or more program (software module) may be provided. The one or more program stored in the computer-readable storage medium is configured for execution by one or more processor in the electronic device. The one or more program include instructions that cause the electronic device to execute methods according to embodiments described in the claim or the specification of the disclosure.

Such program (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile disc (DVD) or other form of optical storage, magnetic cassette. Alternatively, it may be stored in a memory configured with some or all combinations thereof. In addition, each configuration memory may be included a plurality.

In addition, the program may be stored in an attachable storage device that may be accessed through a communication network, such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may access a device performing an embodiment of the disclosure.

In the above-described specific embodiments of the disclosure, the component included in the disclosure is expressed in singular or plural according to the presented specific embodiment. However, singular or plural expression is chosen appropriately for the situation presented for convenience of explanation, and the disclosure is not limited to singular or plural component, and even if the component is expressed in plural, it may be configured with singular, or even if it is expressed in singular, it may be configured with plural.

Meanwhile, in the detailed description of the present disclosure, the specific embodiment have been described, but it goes without saying that various modification is possible within the limit not departing from the scope of the present disclosure.

What is claimed is:

1. An electronic device including a sub-array module comprising:
an antenna substrate;
a plurality of antenna element units;
a first divider for a first polarization; and
a second divider for a second polarization, and
wherein each antenna element unit of the plurality of antenna element units includes:
an antenna element for an emission of a signal,
a first feeding structure for the first polarization,
a second feeding structure for the second polarization,
a first connecting structure for branching the first feeding structure and the first divider, and
a second connecting structure for branching the second feeding structure and the second divider.

2. The electronic device of claim 1,
wherein the first connecting structure is configured to reduce a reactance of a characteristic impedance from a branch of the first divider to the antenna element, and
wherein the second connecting structure is configured to reduce a reactance of a characteristic impedance from a branch of the second divider to the antenna element.

3. The electronic device of claim 1, wherein the first feeding structure and the second feeding structure are disposed to support a corresponding antenna element.

4. The electronic device of claim 3,
wherein a shape of the first connecting structure includes a first connecting part coupled to a branch of the first divider and a first linear part for feeding to the first feeding structure, and
wherein a shape of the second connecting structure includes a second connecting part coupled to a branch of the second divider and a second linear part for feeding to the second feeding structure.

5. The electronic device of claim 4,
wherein the shape of the first connecting structure further includes a first protrusion part having a shape bent with respect to the second linear part, and
wherein the shape of the second connecting structure further includes a second protrusion having a shape bent with respect to the second linear part.

6. The electronic device of claim 4,
wherein the shape of the first connecting structure includes at least one stub disposed based on a direction perpendicular to a feeding direction from the first connecting structure to the first feeding structure, and
wherein the shape of the second connecting structure includes at least one stub disposed based on a direction perpendicular to a feeding direction from the second connecting structure to the second feeding structure.

7. The electronic device of claim 1,
wherein the antenna element unit further includes:
a third connecting structure for branching the first divider,
a fourth connecting structure for branching the second divider,
a third feeding structure connected to the third connecting structure, and
a fourth feeding structure connected to the fourth connecting structure,
wherein the first feeding structure and the third feeding structure are disposed based on a direction of the first polarization, and
wherein the second feeding structure and the fourth feeding structure are disposed based on a direction of the second polarization.

8. The electronic device of claim 1,
wherein another antenna element unit among the plurality of antenna element units includes:
another antenna element,
a fifth feeding structure for another branch of the first divider,
a sixth feeding structure for another branch of the second divider,
a fifth connecting structure for branching the fifth feeding structure and the first divider, and
a sixth connecting structure for branching the fifth feeding structure and the second divider, and
wherein the fifth feeding structure and the sixth feeding structure are configured to reduce a reactance of the other antenna element.

9. The electronic device of claim 1, includes a metal plate for ground,
wherein the antenna substrate is disposed on one surface of the metal plate.

10. The electronic device of claim 1,
wherein the antenna substrate is formed by at least a part of a dielectric, and
wherein a shape of the dielectric includes at least one support part for supporting the antenna element for each of the plurality of antenna element units.

11. An electronic device comprising:
a processor;
radio frequency (RF) processing chains;
a filter; and
an antenna array module including a plurality of sub-array modules,
wherein each sub-array module of the plurality of sub-array modules includes:
an antenna substrate,
a plurality of antenna element units,
a first divider for a first polarization, and
a second divider for a second polarization, and
wherein each antenna element unit of the plurality of antenna element units includes:
an antenna element for an emission of a signal,
a first feeding structure for the first polarization,
a second feeding structure for the second polarization,
a first connecting structure for branching the first feeding structure and the first divider, and
a second connecting structure for branching the second feeding structure and the second divider.

12. The electronic device of claim 11,
wherein the first connecting structure is configured to reduce a reactance of a characteristic impedance from a branch of the first divider to the antenna element, and
wherein the second connecting structure is configured to reduce a reactance of a characteristic impedance from a branch of the second divider to the antenna element.

13. The electronic device of claim 11, wherein the first feeding structure and the second feeding structure are disposed to support a corresponding antenna element.

14. The electronic device of claim 12,
wherein a shape of the first connecting structure includes a first connecting part coupled to the branch of the first divider and a first linear part for feeding to the first feeding structure, and
wherein a shape of the second connecting structure includes a second connecting part coupled to the branch of the second divider and a second linear part for feeding to the second feeding structure.

15. The electronic device of claim 14,
wherein the shape of the first connecting structure further includes a first protrusion part having a shape bent with respect to the second linear part, and
wherein the shape of the second connecting structure further includes a second protrusion having a shape bent with respect to the second linear part.

16. The electronic device of claim 14,
wherein the shape of the first connecting structure includes at least one stub disposed based on a direction perpendicular to a feeding direction from the first connecting structure to the first feeding structure, and
wherein the shape of the second connecting structure includes at least one stub disposed based on a direction perpendicular to a feeding direction from the second connecting structure to the second feeding structure.

17. The electronic device of claim 11,
wherein the antenna element unit further includes:
a third connecting structure for branching the first divider,
a fourth connecting structure for branching the second divider,
a third feeding structure connected to the third connecting structure, and
a fourth feeding structure connected to the fourth connecting structure,
wherein the first feeding structure and the third feeding structure are disposed based on a direction of the first polarization, and
wherein the second feeding structure and the fourth feeding structure are disposed based on a direction of the second polarization.

18. The electronic device of claim 11,
wherein another antenna element unit among the plurality of antenna element units includes:
another antenna element,
a fifth feeding structure for another branch of the first divider,
a sixth feeding structure for another branch of the second divider,
a fifth connecting structure for branching the fifth feeding structure and the first divider, and
a sixth connecting structure for branching the fifth feeding structure and the second divider, and
wherein the fifth feeding structure and the sixth feeding structure are configured to reduce a reactance of the other antenna element.

19. The electronic device of claim 11, includes a metal plate for ground,
wherein the antenna substrate is disposed on one surface of the metal plate.

20. The electronic device of claim 11,
wherein the antenna substrate is formed by at least a part of a dielectric, and
wherein a shape of the dielectric includes at least one support part for supporting the antenna element for each of the plurality of antenna element units.
